(19) United States
(12) Patent Application Publication
(10) Pub. No.: US 2011/0284168 A1
(43) Pub. Date: Nov. 24, 2011

(54) Tire Belt Manufacturing Method And Apparatus

(75) Inventors: Tetsuo Tatara, Osaka (JP); Tomoyuki Takatsuka, Osaka (JP); Hirokatsu Mizukusa, Osaka (JP); Osamu Fujiki, Osaka (JP)

(73) Assignee: TOYO TIRE & RUBBER CO., LTD., Osaka (JP)

(21) Appl. No.: 13/165,925

(22) Filed: Jun. 22, 2011

Related U.S. Application Data
(62) Division of application No. 11/909,484, filed on Jan. 9, 2008.

(30) Foreign Application Priority Data
Mar. 29, 2005 (JP) PCT/JP2005/005838

(51) Int. Cl. B29D 29/00; B29D 30/24

(52) U.S. Cl. 156/350; 156/394.1; 156/397

(57) ABSTRACT

In obliquely cutting a belt band-shaped material (B) to a predetermined length and joining belt material pieces (b) as cut to fabricate a belt member (B10) for a tire, according to the invention, a space, in which an apparatus is mounted, is decreased, a belt member of good quality and high accuracy of joining is manufactured, a cut processing section (A1) for a band-shaped material and an alignment processing section (A2) for belt material pieces as cut are arranged in parallel, in the cut processing section, whenever the band-shaped material (B) is intermittently forwarded, a leading end portion of the band-shaped material is held on a holding table 40 and obliquely cut by a cutter unit (30), the belt material pieces (b) as cut are attracted and held on an underside of a holding member (53) of a transfer unit (T) to be transferred onto and placed on an alignment conveyor (60) with oblique cut ends trued up, and in the alignment processing section, whenever a belt material piece (b) is transferred, the alignment conveyor (60) is intermittently forwarded and the respective belt material pieces are sequentially aligned and joined to form a belt member with reinforcement cords inclined.

### TECHNICAL FIELD

The present invention relates to a method of and an apparatus for manufacturing a tire belt formed by cutting a belt member used for a belt layer in a pneumatic tire, in particular, a belt member, of which reinforcement cords are inclined, from a belt band-shaped material, which is lengthy and relatively small in width, to align and join the same.

### BACKGROUND ART

Conventionally, with a belt layer in a pneumatic tire, a band-shaped material having a relatively large width and having steel cords, which are a multiplicity of reinforcement cords, embedded and processed in parallel in a rubber material is obliquely cut to a length corresponding to a belt width of a tire being an object of manufacture, respective band-shaped pieces as cut are trued up with cut ends thereof at both edges and joined at sides thereof to form a lengthy belt material having a predetermined belt width, and the belt material is wound in a roll fashion to be supported on a carriage, etc. to be stocked.

In a tire forming process in tire manufacture, when a belt is stuck and formed, the lengthy belt material wound in a roll fashion is drawn from the carriage, etc. and cut to a length corresponding to a circumference of a belt layer in a direction, along which the reinforcement cords extend, thereby obtaining a belt member constituting a belt layer in a tire.

Since a belt member for a tire is different in width and length depending upon a tire size, however, there is a need of forming many kinds of belt materials according to kinds and sizes of tires being manufactured to stock the same. Therefore, there is a need for a space for stock, which is considerably large, in a tire manufacturing factory. Also, while a belt material conformed to a tire being an object of manufacture is selected from a multiplicity of belt materials stocked and conveyed to a forming process to be used, works of such selection, conveyance, and exchange are quite troublesome responsible for obstructing improvement in productivity. Especially, in case of the job shop type production, it is necessary to frequently perform a stage exchange work for the exchanging of a carriage, which supports the belt materials.

In recent years, Patent Documents 1 and 2 disclose, as the solution of the conventional problem, an arrangement, in which a constant rate feeding unit for a band-shaped material having a relatively small width and having a plurality of reinforcement cords embedded in a rubber material is arranged obliquely at a predetermined angle to a conveyance conveyor, the band-shaped material is cut obliquely to a length thereof to provide strip-shaped belt material pieces (strip pieces) having a predetermined length while the band-shaped material and the conveyance conveyor are alternately moved intermittently in synchronism with each other, the belt material pieces are transferred onto the conveyance conveyor and aligned by a splice unit with sides of respective belt material pieces butting against one another to be joined together, whereby a belt member having a length corresponding to a circumference of a tire is fabricated.

In case of resorting to such method, however, the constant rate feeding unit is arranged obliquely relative to the conveyance conveyor for alignment of the belt material pieces to feed the band-shaped material obliquely, so that a whole facility for a manufacturing apparatus for the belt member needs a larger space than that in the case where the conveyance conveyor and the constant rate feeding unit are arranged in parallel. Also, at the time of angular adjustment, it is necessary to change an angle of the constant rate feeding unit and it is also necessary to change an angle of the splice unit for joining, so that mechanisms for such adjustment and change are large-scaled and it takes much time in regulating.

Further, when a multiplicity of belt material pieces obtained by obliquely cutting the band-shaped material of small width to a predetermined length are aligned and joined to fabricate a belt member, in the case where cut of the band-shaped material and alignment of belt material pieces as cut are not performed accurately, there is a fear that the accuracy of joining is affected, joining becomes nonuniform and incomplete, and distortion is generated, and so it is not possible to efficiently obtain a belt member of good quality. In case of using a belt member with distortion and a belt member being nonuniform in joining, a tire is impaired in uniformity.

Accordingly, in the case where a belt member is fabricated by aligning and joining a multiplicity of belt material pieces obtained by cutting the band-shaped material in the manner described above, it is an important factor in obtaining a belt member of good quality that simple means can suppress generation of distortion at the time of cut, distortion at the time of transfer and alignment, and distortion at the time of joining.
Patent Document 1: JP-A-11-99564
Patent Document 2: JP-A-2000-280373

### DISCLOSURE OF THE INVENTION

### Problems that the Invention is to Solve

The invention has been thought of in order to solve the problem described above and provides a method of and an apparatus for manufacturing a tire belt, in which an installation space for a whole apparatus is not made large, respective processes of cut, transfer, alignment, etc. are performed stably, joining is high in accuracy, a belt member of good quality can be manufactured efficiently, and an angle of cutting a band-shaped material can be readily regulated in the case where a belt band-shaped material being lengthy and relatively small in width is cut obliquely to a predetermined length corresponding to a belt width and the cut belt material pieces having a predetermined length are joined to fabricate a belt member having a length corresponding to a circumference of a tire.

### Means for Solving the Problem

The invention has a feature in a method of manufacturing a tire belt used for manufacture of a tire, wherein a cut processing section for cutting a lengthy belt band-shaped material with metallic reinforcement cords embedded in parallel in a rubber material to a predetermined linear dimension while feeding the belt band-shaped material intermittently in a longitudinal direction, and an alignment processing section for aligning and joining belt material pieces thus cut and having a predetermined length on an alignment conveyor are arranged in parallel to each other, in the cut processing section, the belt band-shaped material drawn from a material feeding section is intermittently fed by a set linear dimension, a leading end portion of the band-shaped material is caused to pass a portion of a cutter unit every one feed to be held on a holding table forwardly of the cutter unit in a feed direction, and in this held state, the leading end portion of the band-shaped material is cut obliquely to a length thereof by the cutter unit to provide a strip-shaped belt material piece having both longitudinal ends thereof cut obliquely, thereafter, the cut belt material piece is held by holding means provided on a transfer unit, which bridges the cut processing section and the alignment processing section, to be transferred onto an alignment conveyor of the alignment processing section from the holding table and to be turned with the obliquely cut ends oriented in the same direction as a conveyance direction of the alignment conveyor to be placed on the alignment conveyor with the cut ends trued up, and in the alignment processing section, whenever the belt material piece is transferred onto the alignment conveyor, the alignment conveyor is intermittently forwarded by a dimension corresponding to the belt material piece to sequentially align respective belt material pieces to join sides thereof to form a belt member with the reinforcement cords inclined.

According to the invention, since respective processes including oblique cutting of a leading end portion of a belt band-shaped material fed intermittently, transfer of a cut belt material piece to the alignment conveyor, alignment thereof, and joining thereof are carried out in a state, in which the band-shaped material and the cut belt material piece are held at all times in predetermined position and posture. Therefore, at the time of cutting, movement of a band-shaped material can be restricted, the band-shaped material can be exactly cut at a predetermined length set corresponding to a belt width and in an oblique direction of a predetermined angle without generation of distortion, and displacement, movement, etc. at the time of transfer of a belt material piece after being cut and alignment can be restricted, so that it is possible to true up oblique cut ends in orientation and in a predetermined position on the alignment conveyor to achieve transfer and alignment without generation of distortion. Accordingly, although the cut processing section and the alignment processing section are arranged in parallel, it is possible to exactly and uniformly join respective belt material pieces, thus enabling obtaining a belt member of good quality.

In the belt manufacturing method, a belt member having a length corresponding to a circumference of a tire and formed by aligning and joining belt material pieces on the alignment conveyor can be forwarded directly onto a forming drum in a tire forming process from the alignment conveyor. Thereby, it is possible to heighten a tire in efficiency of forming.

Also, an apparatus for manufacturing a tire belt, according to the invention, is used in carrying out the method of manufacturing, comprises a cut processing section for cutting a lengthy belt band-shaped material with metallic reinforcement cords embedded in parallel in a rubber material to a predetermined linear dimension while feeding the belt band-shaped material intermittently in a longitudinal direction, an alignment processing section, which includes an alignment conveyor arranged in parallel to the cut processing section and sequentially aligns and joins belt material pieces as cut on the alignment conveyor, and a transfer unit, which transfers the belt material piece cut in the cut processing section onto the alignment conveyor, and has a feature in that the respective elements are constructed in the following manner.

The cut processing section comprises a material feeding section for holding the lengthy belt band-shaped material in a drawable manner, a constant rate feeding unit for intermittently feeding the band-shaped material, which is drawn from the material feeding section, by a set, predetermined length along a predetermined feeding section, a cutter unit for cutting a leading end portion of the band-shaped material to a predetermined length obliquely to a longitudinal direction whenever the band-shaped material is intermittently fed by the constant rate feeding unit, and a holding table for receiving the leading end portion of the band-shaped material having passed a portion of the cutter unit forwardly of the cutter unit in a feed direction to hold the same in a predetermined position.

The transfer unit comprises a moving body bridging the cut processing section and the alignment processing section thereabove in an intersecting direction to be able to reciprocate, and is provided so that holding means for attracting and holding the belt material piece is supported on the moving body to go up and down and to turn, after the cut by the cutter unit, the belt material piece as cut on the holding table is attracted and held by the holding means to be lifted to be transferred onto the alignment conveyor of the alignment processing section and to turn with an oblique cut end thereof oriented in the same direction as a conveyance direction of the alignment conveyor to be placed on the alignment conveyor with a cut end thereof trued up.

The alignment processing section is provided so that whenever the belt material piece is transferred onto the alignment conveyor, the alignment conveyor is intermittently forwarded by a dimension substantially corresponding to the belt material piece to sequentially align respective belt material pieces'obliquely to join sides thereof.

With the apparatus for manufacturing a tire belt according to the invention, the cut processing section for cutting a lengthy belt band-shaped material to a predetermined linear dimension and the alignment processing section for aligning and joining belt material pieces as cut on the alignment conveyor are arranged in parallel to each other whereby it is possible to decrease an installation space for a whole facility and apparatus for manufacture of a tire. Besides, in a state of being held on the holding table, the band-shaped material can be surely cut to a predetermined length in an oblique direction at a predetermined angle without generation of distortion. Furthermore, the strip-shaped belt material piece as cut can be automatically transferred onto and aligned on the alignment conveyor while being attracted and held by the holding means of the transfer unit, and the respective belt material pieces can be joined accurately and uniformly at the time of transfer and alignment without generation of distortion, displacement, etc. Therefore, the manufacturing method described above can be carried out favorably and although belt material pieces having a relatively small width are joined, it is possible to manufacture a belt member, which is generally well-balanced and has a good quality, efficiently.

The apparatus for manufacturing a tire belt can comprise, as a feeding section of the belt band-shaped material drawn from the material feeding section, a feed table for maintaining the band-shaped material horizontal to feed the same in a longitudinal direction, and holding means provided below a position in the vicinity of an end of the feed table toward the cutter unit to hold the belt band-shaped material on the feed table at the time of cut by the cutter unit. Thereby, not only that leading end portion of the band-shaped material as intermittently fed, which has passed a portion of the cutter unit, but also the band-shaped material can be held on the feed table, so that it is possible to surely cut the band-shaped material in a state, in which movement of the band-shaped material is restricted on both sides of the cutter unit.

In the manufacturing apparatus, preferably, the cutter unit includes cutter blades paired vertically to interpose therebetween a fed portion of the belt band-shaped material and is provided so that the both cutter blades can cut the band-shaped material obliquely to a length thereof and an oblique angular direction of the both cutter blades relative to a length of the band-shaped material can be changed. Preferably, it is possible to mechanically surely cut the band-shaped material containing metallic reinforcement cords such as steel cords, etc. and to readily change and regulate a cut angle by the cutter blades to a length of the band-shaped material.

Also, preferably, an upper one of the vertical pair of cutter blades of the cutter unit is mounted to an arm member, which is connected to a cam shaft rotated by a servomotor to move vertically. Thereby, the band-shaped material can be cut with the use of a servomotor of a relatively small capacity.

The holding table includes a table body, which receives a leading end portion of the belt band-shaped material, and a pair of positioning guides are provided on both sides of the table body to enable displacement in a manner to interpose the band-shaped material as fed between both sides. Thereby, a leading end portion of the band-shaped material can be positioned and held in a predetermined position without generation of distortion to be cut without displacement, and hence transfer, alignment, and joining after cut can be performed without generating of displacement.

The holding table is supported to be able to advance and retreat in a feed direction of the belt band-shaped material and can be provided so that after the band-shaped material is cut, it advances forward in the feed direction in a state of holding a belt material piece as cut and is separated from the cutter unit. Thereby, a belt material piece as cut can be separated from a portion of the cutter unit and the cut belt material piece on the holding table can be surely attracted and held by the holding means of the transfer unit without being obstructed by the cutter unit, thus enabling performing the transfer action without any problem.

The alignment conveyor can be provided with magnetic attraction means, which is approximate to a back surface of a conveyor body in the vicinity of a position, to which the belt material piece is transferred by the transfer unit, to hold the belt material piece on the conveyor body. Thereby, a belt material piece transferred by the transfer unit can be placed stably in a predetermined position on the alignment conveyor, and even when holding by the holding means provided on the transfer unit is released thereafter, the belt material piece on the alignment conveyor will not be moved and displaced, so that joining to a belt material piece being transferred subsequently can be exactly performed.

The alignment conveyor is mounted so that a forward side end thereof is opposed to a forming drum positioned to have a belt member stuck thereto in manufacture of a tire, comprises a stick hand unit including a moving body capable of reciprocating between above the conveyor and above the forming drum and a holding body, on which attraction means capable of advancing and retreating downward is arranged and which is supported on the moving body to be able to go up and down and turn, and can be provided so that a leading end portion of the belt member on the alignment conveyor is attracted and held by the attraction means to be transferred onto the forming drum synchronized with forwarding of the alignment conveyor to be stuck thereto. Thereby, the belt member formed on the alignment conveyor can be forwarded directly onto the forming drum in a tire forming process to be stuck and formed thereon.

The material feeding section is provided below a forwarding section, which feeds the belt band-shaped material in a longitudinal direction, to enable drawing the band-shaped material in an opposite direction to the feed direction, and can be constructed to change orientation of the band-shaped material as drawn to feed the band-shaped material upward to the forwarding section from a rear end side in the feed direction. Thereby, it is possible to arrange the material feeding section in a space of the cut processing section, thus enabling setting the whole apparatus and facility compact in layout.

The material feeding section comprises a table of a column including a support shaft to support a plurality of wound bodies, round which the belt band-shaped material is wound in a rolled manner, in parallel at intervals and provided to permit the band-shaped material on the wound body positioned in a predetermined drawn position to be drawn and to bear the support shaft, and provided to be able to move in the axial direction of the support shaft, and can be constructed to sequentially move the respective wound bodies to the predetermined drawn position to permit the respective band-shaped materials to be drawn. Thereby, the work of feeding the band-shaped material is facilitated.

Also, preferably, the material feeding section is provided with an automatic connection device, which connects a leading end of a band-shaped material on the wound body to a trailing end of a band-shaped material previously drawn whenever the wound body is positioned in a predetermined drawn position, whereby band-shaped materials on the respective wound bodies can be supplied while being sequentially and automatically connected together.

### Effect of the Invention

With the method of and the apparatus for manufacturing a tire belt, according to the invention, in the case where a band-shaped material being lengthy and relatively small in width is cut obliquely to a predetermined length corresponding to a belt width and the cut belt material pieces having a predetermined length are joined to fabricate a belt member having a length corresponding to a circumference of a tire, the cut processing section and the alignment processing section are arranged in parallel whereby it is possible to decrease an installation space for the whole facility of the manufacturing apparatus, thus enabling making effective use of a space in a factory.

Furthermore, in particular, the work in respective processes such as cut, transfer, alignment, etc. can be stably performed in a state of being held in predetermined position and posture and respective belt material pieces can be heightened in accuracy of joining without generation of distortion, etc., so that it is possible to manufacture a belt member being homogeneous and good in quality. Besides, since a belt member can be manufactured according to a tire forming cycle in manufacture of a tire, it is possible to increase a tire in producibility. Since an oblique cut angle of a band-shaped material to a length thereof can be changed and regulated only by regulating orientation of cutter blades of the cutter unit, it is possible to readily manufacture many kinds of belt members whenever a tire being manufactured is changed.

### BEST MODE FOR CARRYING OUT THE INVENTION

Subsequently, modes for carrying out the invention will be described on the basis of embodiments shown in the drawings.

FIGS. 1 to 3 show an outline of a whole manufacturing apparatus of an embodiment for carrying out a manufacturing method of a tire belt of the invention, a belt member B10 having a length corresponding to a circumference of a tire and having orientation of cords inclined is manufactured fundamentally by obliquely cutting both ends of a relatively narrow and lengthy belt band-shaped material B, which is obtained by aligning reinforcement cords C made of a metallic material as a magnetic material to embed the same in a rubber material R, to a predetermined length, and aligning and joining strip-shaped belt material pieces b thus obtained so that oblique cut ends thereof are trued up. In addition, the belt band-shaped material is desirably formed to make both end surfaces of the rubber material R inclined surfaces, which are inclined in the same direction, for the joining of the belt material pieces b as cut in a strip-shaped manner, and can be surely joined by overlapping the inclined surfaces on each other.

In the figure, A1 indicates a cut processing section for cutting the belt band-shaped material B (referred below to as band-shaped material) to a predetermined length while feeding the same intermittently in a longitudinal direction, A2 indicates an alignment processing section arranged in parallel to the cut processing section A1 to sequentially align and join the strip-shaped belt material pieces b thus cut on an alignment conveyor 60 described later, and T indicates a transfer device, by which the belt material pieces b having been cut in the cut processing section A1 are transferred to the alignment conveyor 60 in the aligning processing section A2. The band-shaped material B, of which width is usually 20 to 100 mm, preferably 30 to 50 mm, is preferably used but a band-shaped material having a width outside of the range is of course usable.

In addition, while the manufacturing apparatus shown in FIGS. 1 to 3 comprises two manufacturing apparatuses E1, E2 aligned so as to manufacture first and second belt members B10, B20, of which cords are inclined in left-right opposition to each other, the both apparatuses E1, E2 are fundamentally symmetric to each other to be constructed in substantially the same manner, and so one E1 of the manufacturing apparatuses will be described specifically.

The cut processing section A1 comprises a material feeding section 1 holding the lengthy band-shaped material B in a drawable manner, a constant rate feeding unit 20 for intermittently feeding the band-shaped material B, which is drawn from the material feeding section 1, by a set predetermined length along a feeding section, which comprises a feed table 21 described later, a cutter unit 30 for cutting a leading end portion of the band-shaped material B to a predetermined length obliquely to a length, thereof whenever the band-shaped material B is intermittently fed by the constant rate feeding unit 20, and a holding table 40 for receiving the leading end portion of the band-shaped material B having passed a portion of the cutter unit 30 forwardly of the cutter unit 30 in a feed direction to position and hold the same in a predetermined position.

The material feeding section 1 will be described with reference to FIGS. 5 to 7. The material feeding section 1 is provided below the feed table 21 for the feeding of the band-shaped material B in a longitudinal direction so as to enable drawing the band-shaped material B in an opposite direction to the feed direction on the feed table 21, and constructed to change orientation of the band-shaped material B as drawn to feed the band-shaped material upward to the feed table 21 from a rear end side in the feed direction.

In the case shown in the figure, the material feeding section 1 mounts thereon two feed and support sections 1a, 1b arranged longitudinally at intervals. The longitudinal feed and support sections 1a, 1b, respectively, comprise tables 4a, 4b of columns 3a, 3b including cantilever support shafts 2a, 2b to align and support at intervals a plurality (four in the case shown in the figure) of wound bodies Ba, Bb, round which the band-shaped materials B are wound in a rolled manner, provided so as to enable drawing the band-shaped material B on the wound bodies Ba, Bb positioned in predetermined drawn positions and to bear the support shafts 2a, 2b, and provided to be able to move in the axial direction of the support shafts 2a, 2b, and constructed to sequentially move the respective wound bodies Ba, Bb to the predetermined drawn positions to permit the respective band-shaped materials B to be sequentially drawn. While various drive mechanisms for movement can be made use of as moving means for the tables 4a, 4b, ball screw mechanisms 5a, 5b rotationally driven by servomotors are made use of in the case shown in the figure.

The reference numeral 6 in the figure denotes a feed drive roller provided a little downwardly of a rear end of the feed table 21 disposed on a drawn side of the band-shaped material B in the material feeding section 1, and 6a denotes a holding roller paired with the feed drive roller 6 and provided to enable interposing the band-shaped material B between the both rollers 6, 6a to feed the same at a predetermined rate when the feed drive roller 6 is rotationally driven by a motor, or the like.

The material feeding section 1 is provided so that whenever the wound bodies Ba, Bb are positioned in predetermined drawn positions, leading ends of the band-shaped materials B on the wound bodies Ba, Bb can be automatically connected to trailing ends of the band-shaped materials B previously drawn.

With the embodiment shown in the figure, as the means, a receiving board 7 receiving the band-shaped materials B drawn by the feed drive roller 6 is provided on a supported side of the wound bodies Ba, Bb relative to the feed drive roller 6 and a holding unit 8 such as air cylinder, or the like is provided above the receiving board to descend relative to the receiving board 7 to enable pushing the same. Also, standby boards 9a, 9b, respectively, are provided somewhat forwardly upward in a direction, in which the respective wound bodies Ba, Bb on the support shafts 2a, 2b are drawn, to draw leading ends of the respective band-shaped materials B to have the same standing by. Further, a hand unit 10 is provided movably in vertical and longitudinal directions, which grips a leading end of the band-shaped material B on the standby board 9a, 9b to move the same to the receiving board 7.

The hand unit 10 is supported by a moving body 13, which is reciprocated longitudinally by moving means 12 such as a ball screw mechanism rotated by a servomotor, or the like, to enable vertical movements through advance or retreat means such as air cylinder, etc., the hand unit 10 being provided to be controlled appropriately in movement between respective positions of the both standby boards 9a, 9b of the longitudinal feed and support sections 1a, 1b and a position of the receiving board 7.

The band-shaped materials B are connected together as shown in schematic illustrations of FIGS. 8A, 8B, and 8C such that when a sensor 11 such as photoelectric tube, etc. detects a trailing end of a previous band-shaped material B on the receiving board 7, driving of the feed drive roller 6 is stopped, a succeeding wound body Ba or Bb is moved to the drawn position, then the hand unit 10 grips a leading end (a leading end standing by on the standby board 9a or 9b) of a band-shaped material B on the succeeding wound body Ba or Bb to move the same onto the receiving board 7 to overlap the leading end on the trailing end of the previous band-shaped material B, and then the holding unit 8 descends to push the overlapping portions to automatically connect the trailing end of the previous band-shaped material B and the leading end of the succeeding band-shaped material B.

Also, when a band-shaped material B supported on the support shaft 2a or 2b of one of the longitudinal feed and support sections 1a, 1b runs short, the hand unit 10 grips a leading end of a band-shaped material B on the support shaft 2a or 2b of the other of the longitudinal feed and support sections 1a, 1b to move the same onto the receiving board 7 to have the same automatically connected to a trailing end of a previous band-shaped material B by the holding unit 8 in the same manner as described above and as shown in schematic illustrations of FIGS. 9A and 9B. Thereby, continuous supply of a band-shaped material B is made possible.

Band-shaped materials are supplied to the support shafts 2a, 2b of the longitudinal feed and support sections 1a, 1b as shown in FIG. 7 such that a plurality of wound bodies Ba, Bb of band-shaped materials B are supported on a cantilever support shaft 15 on a carriage 14 and when band-shaped materials B on the support shafts 2a, 2b run short, the carriage 14 is moved to engage and connect an end of the support shaft 15 to an end of the support shaft 2a or 2b to slide the wound bodies Ba, Bb to transfer the same onto the support shaft 2a or 2b to support the same thereon.

A band-shaped material B forwarded by the feed drive roller 6 is changed upward in direction through a dancer section 17 to be fed onto the feed table 21 extending horizontally rearward.

In order to receive the band-shaped material B fed from under, the feed table 21 is formed so that a supply side end thereof is bent downward and a horizontal portion thereof contiguous to the end is substantially concave in cross section to comprise guides 21a, 21a on both sides thereof with a spacing therebetween corresponding to a width of the band-shaped material B to enable feeding the band-shaped material B longitudinally without strain.

As shown in FIGS. 5, 12, and 13, the constant rate feeding unit 20 provided along the feed table 21 includes moving means 22, such as a ball screw mechanism, etc., rotationally driven by a servomotor along the feed table 21 and a moving body 23 supported by the moving means 22 to be moved along the feed table 21. Further, a holding member 25 is supported above the feed table 21 by the moving body 23 so that it can be lifted by a cylinder unit 25a such as air cylinder, etc., the holding member including a plurality of magnetic attraction means 24 provided longitudinally of the feed table 21 at predetermined intervals, having a magnet at a tip end thereof, and capable of advancing or retreating downward.

The holding member 25 includes a holding plate 26 pushed against a band-shaped material B on the feed table 21 by the descending action of the cylinder unit 25a and a support plate provided above the holding plate 26 with a spacing therebetween, the magnetic attraction means 24 are mounted to the support plate 27 and enabled by a cylinder unit 24a to project downward, and in a state, in which the band-shaped material B on the feed table 21 is held by the holding plate 26, tip ends (lower ends) of the magnetic attraction means 24 are caused by the actuation of the cylinder units 24a to project downward through through-holes 26a provided on the holding plate 26 whereby the band-shaped material B can be attracted magnetically, that is, held making use of magnetic attraction forces on the inner reinforcement cords C. The holding member 25 is provided to move a predetermined distance along the feed table 21 in a feed direction owing to movement of the moving body 23 in a state of magnetically attracting the band-shaped material B to feed the band-shaped material B in the feed direction and to thereafter release the magnetic attraction to return to its original position whereby the band-shaped material B is fed by a set predetermined length to a portion of the cutter unit 30 described later. Accordingly, the magnetic attraction means 24 is controlled in advance or retreat action according to the feed action of the band-shaped material B. As holding means for the feed of the band-shaped material B, use of the magnetic attraction means 24 as described above is preferable by virtue of control being made easy, but other holding means such as suction means, etc. can be instead made use of.

With the apparatus of the embodiment shown in the figure, magnetic attraction means 28 enabled by a cylinder unit 28a to advance or retreat upward are arranged, as holding means for the restriction of movement of the band-shaped material B, below a position in the vicinity of an end of the feed table 21 toward the cutter unit 30 as shown in FIGS. 10 and 11, and provided so that at the time of cutting with the cutter unit 30 tip ends of the magnetic attraction means 28 project upward to extend through the feed table 21 to appear above the table whereby the band-shaped material B on the feed table 21 is attracted and held. Therefore, the feed table 21 is provided with through-holes 21b, through which tip ends of the magnetic attraction means 28, which include magnets, can extend. The holding action by the magnetic attraction means 28 is controlled according to the action of feeding the band-shaped material B. The reference numeral 29 denotes an encoder for detection of feed when the band-shaped material B is fed at a constant rate. As means for holding the band-shaped material B, suction means, and other holding means capable of holding the band-shaped material B on the feed table 21 can be made use of, in which case the feeding action is also controlled in the same manner as that described above.

The cutter unit 30 is provided forwardly of the feed table 21 in a feed direction to include cutter blades 31, 32 paired vertically as shown in FIGS. 14 to 16 to interpose therebetween a fed portion of the band-shaped material B fed by the feed table 21 and arranged obliquely relative to a length of the band-shaped material B as viewed in plan view, and provided so that the both cutter blades 31, 32 cut a leading end portion of the band-shaped material B by a predetermined length obliquely at a predetermined inclination to a longitudinal direction whenever the constant rate feeding unit 20 intermittently feeds the band-shaped material B.

With the cutter unit 30 shown in the figure, the lower cutter blade 32 out of the pair of the upper and lower cutter blades 31, 32 is a stationary blade extending along an underside of the fed portion of the band-shaped material B to be fixed to a holding frame member 33, and the upper cutter blade 31 is a moving blade mounted to an arm member 36, which is connected to a cam shaft 35 rotated by a servomotor 34 above the fed portion of the band-shaped material B to move up and down, so that the upper cutter blade 31 descends to a position, in which it slides on the lower cutter blade 32, upon rotation of the cam shaft 35 whereby the band-shaped material B between the both upper and lower cutter blades 31, 32 is cut obliquely. In the case shown in the figure, the camshaft 35 is supported rotatably on an upper portion of the frame member 33 to be connected to the servomotor 34, the arm member 36 is pin-connected to a connecting member 37, which is fitted onto a cam 35a on the cam shaft 35 to move up and down, and when the cam shaft 35 is rotated by the servomotor 34, the cutter blade 31 mounted to the arm member 36 moves up and down.

The cutter unit 30 is provided to enable changing and regulating an angular direction of the both cutter blades 31, 32 inclined to the band-shaped material B, that is, a cut angle inclined to the band-shaped material B. As means therefor, for example, the frame member 33 for the holding of the cutter blade is supported to turn relative to a lower support 38 fixed to the apparatus frame about a vertical axis passing through substantially intermediate portions of the both cutter blades 31, 32, and the frame member 33 is turned a predetermined angle by turning means 39, such as servomotor, etc., provided on the lower support 38. Of course, other turning and supporting means can be made use of. The reference numeral 31a denotes a manually operated handle for vertical movement of the cutter blade 31, the handle being mounted to the cam shaft 35.

As shown in FIGS. 17 and 18, the holding table 40 includes a table body 41 having a predetermined length and provided on a table support base plate 40a to bear a leading end portion of the band-shaped material B, a pair of plate-shaped guide bars 42, 42 for interposing the leading end portion of the band-shaped material B between both sides thereof to position the same, and holding means for holding the leading end portion on the table body 41. That is, as an example of the holding means, a plurality of magnetic attraction means 43 having magnets at tip ends thereof and capable of advancing and retreating upward are arranged below the table body 41 and along a length of the table body 41 to attract the leading end portion of the band-shaped material B from under to hold the same on the table body 41.

In the case shown in the figure, the table body 41 has a little smaller width than that of the band-shaped material B and extends on the support base plate 40a in a feed direction, and the guide bars 42, 42 are arranged in opposition to each other on both sides of the support base plate 40a with the table body 41 therebetween and provided to be displaced in a mutually opposite direction upon the actuation of cylinder units 44, 44, such as air cylinder, etc., connected to the guide bars 42, 42. The reference numerals 45, 45 denote support guides, by which the displacement is correctly made. The cylinder units 44 and the support guides 44 are provided on the support base plate 40a.

Also, the plurality of magnetic attraction means 43 are mounted to and supported on a lower support plate 46a for a holding member 46 connected to an underside of the support base plate 40a to be enabled by cylinder units 43a to project upward, and the tip ends (upper ends) are caused by the actuation of the cylinder units 43a to project upward through through-holes 41a provided on the support base plate 40a and the table body 41, thereby enabling magnetically attracting and holding the leading end portion of the band-shaped material B positioned on the table body 41. In a state, in which the band-shaped material B is attracted and held, the cutter unit 30 is set to perform the cutting operation. The holding action by the magnetic attraction means 43 is released when the magnetic attraction means are retreated (lowered) downward by the cylinder units 43a.

Also, the whole of the holding table 40 including the table body 41 and the holding member 46 for the magnetic attraction means 43 is supported to be able to advance and retreat in a feed direction (a longitudinal direction of the table body 41) of the band-shaped material B and provided so that after the band-shaped material B is cut, a belt material piece b as cut is caused to advance forwardly of the portion of the cutter unit 30 in the feed direction while being held by the magnetic attraction means 43 and the belt material piece b can be separated from a side of the lengthy band-shaped material B.

As shown in FIGS. 18 and 19, there are provided, as means therefor, moving means 48, such as a ball screw mechanism, etc., arranged below the holding table 40 and rotationally driven by a servomotor in the feed direction of the band-shaped material B, and a moving body 49 supported and reciprocated by the moving means 48 in the feed direction, the holding member 46 being connected to and supported by the moving body 49, the moving body 49 moving forward in the feed direction whereby the whole holding table 40 moves in a state of holding the belt material piece b and separates the belt material piece from the portion of the cutter unit 30. In the separated position, the belt material piece b is held by holding means of a transfer unit T described later to be transferred. In case of making use of other means such as suction or the like, holding means for holding the leading end portion of the band-shaped material B is also likewise constituted. The reference numeral 47 denotes an encoder for detection of feed of the band-shaped material B.

As shown, in enlarged scale, in FIGS. 20 to 22, the transfer unit T for transferring the belt material piece b to the alignment processing section A2 from the cut processing section A1 is constructed in the following manner.

Moving means 50, such as a ball screw mechanism, etc., rotationally driven by a servomotor is arranged to bridge the cut processing section A1 and the alignment processing section A2 above the both processing sections in an intersecting direction (mainly, a perpendicular direction), and a moving body 51 is provided to be supported by the moving means 50 and reciprocated bridging the both processing sections A1, A2. Holding means for holding the belt material piece b is supported on the moving body 51 to enable lifting and turning about an axis in a vertical direction. In the case shown in the figure, there is provided, as the holding means, a holding member 53 including a plurality of magnetic attraction means 52 having magnets at tip ends (lower ends) thereof and capable of advancing and retreating downward. Specifically, moving means 55 for lifting, such as a ball screw mechanism, etc., rotationally driven by a servomotor is mounted to the moving body 51, a lifting member 56 supported and lifted by the moving means 55 is provided, turning means 57 such as servomotor, etc. is provided on the lifting member 56 to define a vertical axis, and the holding member 53 is mounted to the turning means 57 to appropriately lift and turn upon control of operations of the moving means 55 for lifting and the turning means 57.

The holding member 53 has a length corresponding substantially to a length of the belt material piece b held on the table body 41 of the holding table 40 and cut, especially preferably, a little larger length than a largest length of the belt material piece b so as to enable attracting and holding the belt material piece b in a horizontal posture without slack in the following manner.

The holding member 53 includes a holding plate 58 capable of fitting between the both guide bars 42, 42 to push and abut against the belt material piece b held in a position separated from the cutter unit 30 and between the both guide bars 42, 42 owing to the descending operation by the moving means 55, and a support plate 59 provided above the holding plate 58 with a spacing therebetween. The plurality of magnetic attraction means 52 are mounted at predetermined longitudinal intervals on the support plate 59 to be enabled by cylinder units 52a to project downward, and in a state, in which the holding plate 58 holds the belt material piece b on the table body 41, tip ends (lower ends) of the magnetic attraction means 52 are caused by the actuation of the cylinder units 52a to project downward through through-holes 58a provided on the holding plate 58 whereby the belt material piece b can be attracted magnetically. The magnetic attraction means 43 of the holding table 40 are provided to release attraction after the action of magnetic attraction of the magnetic attraction means 52.

The moving means 50, which bridges the cut processing section A1 and the alignment processing section A2, the moving means 55 for lifting, and the turning means 57 are set so that the moving means 55 for lifting operates in a state, in which the belt material piece b is attracted to the holding member 53 by the magnetic attraction means 53, to raise the holding member 53, which attracts and holds the belt material piece b, to lift the belt material piece b, the moving means 50 operates in the lifted state to transfer the belt material piece together with the moving means 55 for lifting to the alignment conveyor 60 of the alignment processing section A2, the turning means 57 operates during the transfer to turn the holding member 53 obliquely so that an oblique cut end of the belt material piece b is oriented in the same direction as a conveyance direction of the alignment conveyor 60, thereafter the moving means 55 for lifting operates to make a lowering action to place the belt material piece b, which is attracted to and held on an underside of the holding member 53, in a predetermined position on the alignment conveyor 60 with the oblique cut end aligned obliquely, and thereafter attraction of the magnetic attraction means 52 is released to return the belt material piece to a position above the original separated position on the holding table 40.

Also, as shown in FIGS. 23 and 24, the alignment conveyor 60 provided in the alignment processing section A2 is a belt conveyor, of which a conveyor body 61 comprises an endless belt being a little wide corresponding to a maximum width of a belt member being an object of manufacture and being continuous in a ring-shaped manner, and the conveyor body 61 is supported by a support frame 63 in a predetermined position above a frame 62 and provided to receive a belt material piece b transferred by the transfer unit T. The conveyor body 61 is mounted on pulleys 64, 64 arranged on both longitudinal ends of the support frame 63 and provided so that an upper side running portion 61a runs slidingly contacting with a horizontal, upper plate portion 63a of the support frame 63 to be maintained in a horizontal state, a part of a lower side running portion 61b engages with a drive pulley 66, which is rotationally driven by a drive motor 65 such as servomotor, etc., and rotation of the drive pulley 66 causes the upper side running portion 61a to turn in a longitudinal direction. The respective pulleys 64, 64 and the drive pulley 66 comprise a grooved roller having irregularities in a circumferential direction and irregularities provided on a band-shaped member 61c attached to a back surface (inner surface) of the conveyor body 61 mesh with the respective irregularities of the respective pulleys 64, 64, and 66 whereby the conveyor body 61 can turn without slippage. The reference numeral 67 in the figure denotes a tension roller to eliminate slack in the conveyor body 61.

The alignment conveyor 60 is provided so that the support frame 63 is supported on the frame 62 to be enabled by lifting means 69, such as screw jack, etc., which is driven by a motor 68, to go up and down, thus enabling appropriately regulating a level when the belt material piece b is aligned and joined, and a level when a belt member B10, to which the belt material piece b is joined, is forwarded. That is, as described later, in the case where the belt member B10 is forwarded and bonded directly to a belt forming drum D opposed to a forward side end of the alignment conveyor 60, the alignment conveyor is provided so as to enable appropriately regulating a level according to a height, drum diameter, etc. of the belt forming drum D. As an example, the alignment conveyor 60 is regulated in level so as to be held in a higher position than an uppermost surface of a circumference of the belt forming drum D at the time of alignment and joining of the belt material piece b and to be positioned in a level on substantially the same horizontal plane as the uppermost surface of the belt forming drum D. The reference numeral 62a in the figure denotes a support guide for lifting (see FIG. 7).

The alignment conveyor 60 is set so that whenever the drive motor 65 is rotationally controlled to transfer the belt material piece b onto the alignment conveyor 60, the alignment conveyor 60 runs intermittently by a dimension corresponding substantially to the belt material piece b, for example, in an opposite direction (rearward) to a forwarding direction (forward), whereby the respective belt material pieces b sequentially transferred can be aligned sequentially obliquely and sides thereof can be joined together. Setting is made so that when a predetermined length of a belt member B10 being manufactured is reached by alignment and joining of the belt material pieces b, the belt member B10 can be forwarded by rotationally controlling the drive motor 65 to run the alignment conveyor 60.

Further, a plurality of magnetic attraction means 70 composed of magnets being approximate to the back surface of the conveyor body 61 to hold the belt material piece b on the conveyor 61 without displacement are arranged on the upper plate portion 63a of the support frame 63 in the vicinity of a position on the upper side running portion 61a of the conveyor body 61, to which the belt material piece b is transferred by the transfer unit T. The magnetic attraction means 70 are set to a magnetic force having no influence on movement by the conveyor body 61. In the case shown in the figure, the magnetic attraction means 70 are arranged substantially along a transferred position of the belt material piece b, which is obliquely transferred by the transfer unit T with a cut end thereof in a direction of conveyance, and also arranged in the vicinity of both ends of the oblique arranged position in a widthwise direction so as to enable restricting movements of the respective belt material pieces b thus aligned and joined. Further, it is possible to arrange similar magnetic attraction means in a direction, in which the belt material pieces b are aligned, at need.

The alignment conveyor 60 is mounted so that the forward side end thereof is opposed to the belt forming drum D positioned to have the belt member B10 stuck thereto and formed thereon in tire manufacture, and provided so that in a state of being regulated in level to be positioned in substantially the same level as the uppermost surface of the belt forming drum D, the belt member B10 can be forwarded onto the belt forming drum D and simultaneously stuck to and formed on the drum circumference. A scraper 71 is provided at the forward side end of the alignment conveyor 60 to separate the belt member B10 from the conveyor body 61 when the belt member B10 is forwarded. The scraper 71 is provided so that an upper surface thereof is disposed on an extension of an upper surface of the conveyor body 61 and a tip end thereof is disposed approximate to the circumference of the belt forming drum D and positioned in substantially the same level as the uppermost surface.

FIGS. 25 and 26 show a unit for the sticking of the belt member B10. Moving means 72, such as a ball screw mechanism, etc., rotationally driven by a servomotor is provided to extend above the belt forming drum D from above a forward side portion of the alignment conveyor 60, and a moving body 73 is provided to be enabled by the moving means 72 to reciprocate between a region above the alignment conveyor 60 and a region above the belt forming drum D. Moving means 74 for lifting, such as a ball screw mechanism, etc., rotationally driven by a servomotor is mounted to the moving body 73 and a holding member 77, on which magnetic attraction means 76 having magnets at tip ends (lower ends) and capable of advancing or retreating downward are arranged, for example, three holding members 77 in parallel in a direction of conveyance of the alignment conveyor 60 as shown in the figure are connected to a lower portion of a lifting member 75 supported and lifted by the moving means 74 and supported so as to go up and down together with the lifting member 75.

The holding member 77 includes a holding plate 78, which descends in a position above the alignment conveyor 60 to contact with the belt member B10 on the alignment conveyor 60, and a support plate 79 provided above the holding plate 78 with a spacing therebetween, the plurality of magnetic attraction means 76 are mounted longitudinally at predetermined intervals to the support plate 79 by cylinder units 76a to be directed downward, and in a state, in which the belt member B10 on the alignment conveyor 60 is held by the holding plate 78, tip ends (lower ends) of the magnetic attraction means 76 are caused by the actuation of the cylinder units 76a to project downward through through-holes 78a provided on the holding plate 78 whereby the belt member B10 can be magnetically attracted to and held on an underside of the holding plate 78. Thereby, in a state of being held on the underside of the holding plate 78, a tip end of the belt member B10 on the alignment conveyor 60 can be transferred to the belt forming drum D.

As means for holding the belt member B10 on the underside of the holding plate 78, other attracting means (not shown) by suction, etc. can be made use of, in place of the magnetic attraction means 76.

While the central holding member 77A out of the three holding members 77 is fixed to a lower plate 75a of the lifting member 75, the two holding members 77 on both sides are supported slidably on the lower plate 75a through left and right guides 80b and provided to enable left and right displacements by appropriate means, such as a pinion/rack mechanism 80a driven by a servomotor 80, a screw shaft, etc. Thereby, a spacing between the holding members 77 on both sides can be regulated according to a width of the belt member B10 being an object of manufacture.

In addition, the moving speed of the moving body 73 is set to be the same as the forwarding speed corresponding to the belt member B10 being forwarded by the alignment conveyor 60 and further set to correspond to the sticking speed on the peripheral surface of the belt forming drum D. That is, the belt forming drum D rotates as the belt member B10 is forwarded and the sticking speed on the peripheral surface is set to correspond to the forwarding speed.

The reference numeral 81 in the figure denotes a moving base to support the belt forming drum D movably, and 82 a track, on which the moving base 80 moves and which is provided for movement to a position, in which other tire constituent members are formed. For example, in the case where the two manufacturing apparatuses E1, E2 are juxtaposed as shown in FIGS. 1 to 3, the track is provided for movement from a forming position corresponding to one E1 of the manufacturing apparatuses to a forming position corresponding to the other E2 of the manufacturing apparatuses, or to a subsequent forming position.

A method of manufacturing a tire belt with the manufacturing apparatus and an operating state will be described with reference to FIGS. 27, 28, 29, and 30, in which operating steps are shown.

FIGS. 27A to 27E show operating steps of constant rate feeding of a band-shaped material B. Normally, until the continuous operation of the apparatus is started, the band-shaped material B drawn from the material feeding section 1 disposed below the feed table 21 of the cut processing section A1 is changed upward in direction and fed onto the feed table 21 with a rear end thereof at the head, a tip end thereof is forwarded to a position of the cutter unit 30, and the tip end is cut obliquely at a predetermined angle by the cutter unit 30. At this time, the magnetic attraction means 28 provided below a position in the vicinity of an end of the feed table 21 toward the cutter unit 30 ascends to hold the band-shaped material B (FIG. 27A).

The apparatus begins manufacture from the state described above. First, for the constant rate feeding of a band-shaped material B, the cylinder unit 25a (see FIG. 12) operates to lower the holding member 25 provided on the moving body 23 of the constant rate feeding unit 20 provided along the feed table 21 to push and contact the lower surface thereof (the lower surface of the holding plate 26) with the band-shaped material B, and further in this state, the cylinder unit 24a (see FIG. 12) operates to advance and lower the magnetic attraction means 24 provided on the holding member 25 to magnetically attract the band-shaped material B to hold the same on the lower surface of the holding member 25 (FIG. 27B). Also, after the holding, the magnetic attraction means 28 in the vicinity of the end toward the cutter unit 30 is lowered to release the holding operation.

Subsequently, the moving means 22 provided on the constant rate feeding unit 20 operates to move the moving body 23 together with the holding member 25 in the feed direction to feed the band-shaped material B by a predetermined length set according to a width of a belt member B10 being manufactured, an inclination of cords, etc. to have a leading end portion of the band-shaped material B passing the portion of the cutter unit 30 to feed the same onto the holding table 40 forwardly of the cutter unit 30 in the feed direction. Further, when the feeding is suspended, the magnetic attraction means 28 in the vicinity of the end of the feed table 21 toward the cutter unit 30 is caused to ascend to attract the band-shaped material B to hold the same on the feed table 21 (FIG. 27C). At the same time, the leading end portion of the band-shaped material B is positioned in a predetermined position on the holding table 40 to be attracted and held on the holding table 40 by the magnetic attraction means 43.

Thereafter, the magnetic attraction means 24 on the holding member 25 is caused to retreat (ascend) upward to release magnetic attraction and the whole of the holding member 25 is caused to ascend to return to its original position together with the moving body 23 (FIG. 27D). In this state, the cutter unit 30 composed of the upper and lower cutter blades 31, 32 is caused to perform the cutting operation upon descent of, for example, the upper cutter blade 31 to cut the leading end portion of the band-shaped material B obliquely relative to a length thereof to separate a strip-shaped belt material piece b, both ends of which are obliquely cut.

After the cut, the holding table 40 moves forwardly in the feed direction while holding the belt material piece b as cut, so that the belt material piece b is separated (FIG. 27E) and transferred onto the alignment conveyor 60 by the transfer unit T as described later.

Thereafter, the constant rate feeding of a band-shaped material B is likewise carried out intermittently corresponding to the operations of transfer and alignment of the belt material piece b as cut.

FIGS. 28A to 28F show respective operating steps, in which the band-shaped material B being intermittently fed in the manner described above is held and separated after the cut, the belt material piece b is transferred by the transfer unit T, or the like.

When receiving the leading end portion of the band-shaped material B intermittently fed by the constant rate feeding unit 20, the holding table 40 is disposed in a position approximate to the portion of the cutter unit 30 and the positioning guide bars 42, 42 on the both sides of the table body 41 are held so as to preserve a larger spacing than a width of the band-shaped material B. In this state, the leading end portion of the band-shaped material B having passed the portion of the cutter unit 30 is received on the table body 41 (FIG. 28A).

When the feeding operation of the band-shaped material B stops, the guide bars 42, 42 on the both sides are displaced in the mutually opposed directions upon the actuation of the cylinder units 44, 44 (see FIGS. 17 and 18) to interpose the band-shaped material B from both sides to thereby position the same so as to center the same widthwise, and the magnetic attraction means 43 provided below the table body 41 is caused by the actuation of the cylinder units 43a (see FIGS. 17 and 18) to ascend to hold the band-shaped material B on the table body 41 (FIG. 28B). In this held state, the cutter unit 30 performs the cutting operation to cut the leading end portion of the band-shaped material B from a base side (FIG. 28B). At this time, since the magnetic attraction means 28 in the vicinity of the cutter unit 30 performs attraction and holding on the side of the feed table 21, the cut is exactly performed without displacement.

When the cut is completed, owing to the actuation of the lower moving means 48, which supports the holding table 40 movably, the holding table is moved forwardly of a position approximate to the cutter unit 30 in the feed direction while holding the belt material piece b as cut, whereby the belt material piece b is separated from the band-shaped material B from a base side (FIG. 28C).

At this time, the holding member 53 in the transfer unit T, which bridges the cut processing section A1 and the alignment processing section A2, especially, the holding member 53, which is supported so as to enable ascending and turning, is positioned above the position of separation on the holding table 40 and along a length of the belt material piece b on the holding table 40 (FIG. 28D). When the holding table 40 is separated up to a predetermined position, the guide bars 42, 42 provided on the holding table 40 open to release the holding operation of the belt material piece b from both sides thereof, then the holding member 53 descends upon the actuation of the moving means 55 for lifting to have an underside of the holding member 53 contacting with the belt material piece b held on the holding table 40, and further the magnetic attraction means 52 provided on the holding member 53 advances downward upon the actuation of the cylinder units 52a to project below the underside of the holding member 53 to magnetically attract the belt material piece b to hold the same on the lower surface of the holding member 35 (FIG. 28E). Also, at the same time, the magnetic attraction means 43 of the holding table 40 descends to thereby release the attracting and holding operation.

Subsequently, in a state of holding the belt material piece b on the underside thereof, the holding member 53 ascends upon the actuation of the moving means 55 for lifting (FIG. 28F), and the moving means 50, which bridges the cut processing section A1 and the alignment processing section A2, operates, so that as the moving body 51 provided thereon moves, the moving means 55 for lifting, mounted to the moving body 51 and the holding member 53 supported on the lifting member 56 of the moving means 55 for lifting through the turning means 57 move onto the alignment conveyor 60. Also, during such movement, the turning means 57 operates to turn the holding member 53, so that the oblique cut end of the belt material piece b held on the underside of the holding member 53 is changed in direction so as to be oriented in the same direction as the direction of conveyance of the alignment conveyor 60.

Thus the belt material piece b descending from above the alignment conveyor 60 upon the actuation of the moving means 55 for lifting to be held on the underside of the holding member is pushed and contacted in a predetermined position on the alignment conveyor 60, the magnetic attraction means 42 provided on the holding member 53 ascends in this state to release the attracting and holding operation, and further the holding member 53 ascends leaving the belt material piece b upon the actuation of the moving means 55 for lifting whereby the belt material piece b is placed on the alignment conveyor 60 (FIG. 28G).

On the other hand, upon the actuation of the moving body 51, the holding member 53 having ascended returns above the original position of separation on the holding table 40 together with the moving body 52 and turns upon the actuation of the turning means 57 to return to the original state so that a length of the holding member 53 corresponds to a length of the holding table 40. Thereafter, in the same manner, whenever the band-shaped material B is intermittently fed at the constant rate and acts, the belt material pieces b thus cut are repeatedly transferred correspondingly and the respective belt material pieces b are joined.

FIGS. 29A to 29C show operating steps of the belt material piece b in an aligned state on the alignment conveyor 60.

When a strip-shaped belt material pieces b held on the underside of the holding member 53 is transferred onto the alignment conveyor 60 by the transfer unit T so that its oblique cut end is oriented in the same direction as the direction of conveyance of the alignment conveyor 60 (FIG. 29A), the alignment conveyor 60 is forwarded once every transfer a dimension substantially corresponding to the belt material piece b, in particular, a dimension corresponding to a length (f1) of the cut end in an opposite direction to a forward direction of the alignment conveyor 60 as shown in, for example, the figure (FIG. 29B). In this manner, a belt material piece b being transferred by the same transfer action as that described above is aligned and placed with a cut end thereof trued up, in a predetermined position on the alignment conveyor 60, that is, in a predetermined position adjacent to the belt material piece b placed at the last time (chain lines in FIG. 29B), whereby sides of the belt material piece b and sides of the preceding belt material piece b are joined together. At this time, by forming side end surfaces of the belt material piece b to make the same an inclined surface as shown in, for example, FIG. 4, sure joining can be achieved in a state of partial overlap making use of the inclination of the side end surfaces.

In this manner, whenever a belt material piece b is transferred onto the alignment conveyor 60, forwarding the alignment conveyor 60 intermittently by a dimension substantially corresponding to the belt material piece b and sequentially aligning respective belt material pieces b on the alignment conveyor 60 with cut ends thereof trued up to join sides thereof together are repeated whereby it is possible to form a belt member B10 of a predetermined length having reinforcement cords C oriented obliquely (FIG. 29C).

In this manner, since respective processes including oblique cutting of a leading end portion of a belt band-shaped material B fed intermittently, transfer of a cut belt material piece b to the alignment conveyor 60, alignment thereof, and joining thereof are carried out in a state, in which the band-shaped material B and the cut belt material piece b are held at all times by holding means such as the magnetic attraction means, etc., distortion is not generated in cut length and oblique cut angle at the time of cutting, and displacement at the time of transfer of a belt material piece b after being cut, alignment, etc. can be restricted, so that it is possible to true up oblique cut ends in orientation to achieve transfer and alignment without generation of distortion. Accordingly, although the cut processing section A1 and the alignment processing section A2 are arranged in parallel, it is possible to exactly and uniformly join respective belt material pieces b, thus enabling obtaining a belt member B10 of good quality.

While the belt member B10 thus obtained and having a predetermined length can be forwarded onto a carriage, etc. from the forward side end to be once stocked upon the actuation of the alignment conveyor 60, it is forwarded directly onto the forming drum D in the tire forming process as in the illustrated embodiment.

FIGS. 30A to 30E show operating steps in a state, in which the belt member B10 is stuck.

As described above, when a belt member B10 having a predetermined length is formed on the alignment conveyor 60, the alignment conveyor 60 having been held in, for example, a higher position than that of the forming drum D descends upon the actuation of the lifting means 69 and is regulated in level so as to be positioned on a horizontal plane in substantially the same level as the uppermost surface of the belt forming drum D. In this state, the holding members 77 supported through the lifting member 75 on the moving body 73, which is provided to be enabled by the moving means 72 to reciprocate between a region above the alignment conveyor 60 and a region above the forming drum D, descends upon the actuation of the moving means 74 for lifting, the undersides of the holding members 77 push the vicinity of a forward side end of the belt member B10 on the alignment conveyor 60 (FIG. 30A), and further the magnetic attraction means 76 provided on the holding members 77 advance downward upon the actuation of the cylinder units to project below the undersides of the holding members 77 whereby the belt member B10 is attracted and held on the undersides of the holding members 77, in particular, in a state of being interposed between them and the alignment conveyor 60. In this state, the alignment conveyor 60 is driven to convey a belt material piece b in the forward direction, and simultaneously and in synchronism with this, the moving means 72 operates, so that the holding members 77 with a leading end portion of the belt member B10 held on the undersides thereof are moved together with the moving body 73 in the forward direction to stick the leading end portion of the belt member B10 to the circumference of the forming drum D according to rotation of the drum (FIG. 30B).

Subsequently, when sticking corresponding to a length of the holding members 77 is completed, rotation of the forming drum D is stopped, attraction by the magnetic attraction means 76 is released, and the holding members 77 together with the lifting member 75 ascends upon the actuation of the moving means 74 for lifting, further moves onto the alignment conveyor 60 upon the actuation of the moving means 72 in an opposite manner as described above to return to its original position to again descend in a manner to push and contact the belt member B10 on the alignment conveyor 60 to attract and hold the same with the magnetic attraction means (FIG. 30C), and moves in the forward direction corresponding to rotation of the forming drum D, forwarding by the alignment conveyor 60, and rotation of the forming drum D in the same manner as described above while the belt member B10 is held on the undersides of the holding members 77, whereby the belt member B10 is stuck to the circumference of the forming drum D (FIG. 30D).

These operations are repeated to complete sticking the belt member B10 on the alignment conveyor 60 to the forming drum D.

In addition, while the embodiment has been described with respect to the manufacturing apparatus E1 for manufacture of the first belt member B10, the manufacturing apparatus E2 for manufacture of the second belt member B20 mounted in parallel to the former manufacturing apparatus is different from the former manufacturing apparatus in that a cord direction of the belt member B20 being manufactured is inclined oppositely, and can be embodied in fundamentally the same apparatus configuration.

In this case, it is possible to provide, for example, the sticking unit, shown in FIGS. 25 and 26, individually on the two manufacturing apparatuses E1, E2, and the single sticking unit is provided to be movable to positions corresponding to the respective manufacturing apparatuses E1, E2 to be able to serve as sticking and forming the belt members B10, B20 being manufactured in the both manufacturing apparatuses E1, E2.

Further, while the embodiment described above has illustrated the alignment conveyor 60 in the alignment processing section A2 in the case where a direction, in which the belt material piece b is forwarded at the time of alignment and joining, is opposite to a direction, in which the belt member B10 is forwarded after alignment and joining, this is not limitative but the alignment conveyor 60 can be constructed such that alignment and joining of the belt material piece b are performed while the alignment conveyor is intermittently forwarded in the same direction as the forwarded direction of the belt member B10 as shown schematically in FIG. 31, and after a belt member B10 having a predetermined length is manufactured, it is forwarded intact in the direction.

In this case, the cut processing section A1 arranged in parallel to the alignment processing section A2 can be constructed such that the constant rate feeding unit 20, the cutter unit 30, the holding table 40, the transfer unit T, etc. are arranged in the same manner as the embodiment described above and a direction, in which the band-shaped material B is fed, is made the same as a direction, in which the alignment conveyor 60 is forwarded, and such that as shown in FIG. 31, the constant rate feeding unit 20, the cutter unit 30, the holding table 40, the transfer unit T, etc. are arranged in an opposite direction to that in FIG. 1 and a direction, in which the band-shaped material B is fed, is made opposite to a direction, in which the alignment conveyor 60 is forwarded.

It goes without saying that control is exercised even in the both embodiments so that respective operations of supply of the band-shaped material B, feeding by the constant rate feeding unit 20, cut by the cutter unit 30, separation by the holding table 40, transfer by the transfer unit T, alignment and joining on the alignment conveyor 60, forwarding onto the forming drum D, etc. are sequentially carried out.

### INDUSTRIAL APPLICABILITY

A manufacturing method and a manufacturing apparatus of a tire belt of the invention can be preferably made use of in the case where a lengthy band-shaped material for belt having a relatively small width is obliquely cut to a predetermined length corresponding to a belt width and cut belt material pieces having a predetermined length are joined to fabricate a belt member having a length corresponding to a circumference of a tire.

### BRIEF DESCRIPTION OF THE DRAWINGS

FIG. 1 is a schematic, plan view showing an outline of the whole belt manufacturing apparatus according to an embodiment of the invention.

FIG. 2 is a schematic, front view showing the manufacturing apparatus.

FIG. 3 is a schematic, side view showing the manufacturing apparatus.

FIG. 4 is a view illustrating a state, in which a belt member is formed.

FIG. 5 is an enlarged side view showing a material feeding unit and a forwarding unit of the manufacturing apparatus.

FIG. 6 is an enlarged plan view showing the material feeding unit of the manufacturing apparatus.

FIG. 7 is a front view seen from rearwardly of the material feeding unit of the manufacturing apparatus in a feed direction.

FIG. 8A is a schematic, side view illustrating a state of normal feed in one feed and support section of the material feeding unit.

FIG. 8B is a schematic, side view before connection to illustrate an automatic connected state of a band-shaped material.

FIG. 8C is a schematic, side view at the time of connection.

FIG. 9A is a schematic, side view before connection to illustrate an automatic connected state of a band-shaped material in two feed and support sections of the material feeding unit.

FIG. 9B is a schematic, side view at the time of connection.

FIG. 10 is a plan view showing a part of a band-shaped material feed table of the manufacturing apparatus.

FIG. 11 is a side view showing the part of the band-shaped material feed table.

FIG. 12 is a partial side view showing an outline of a band-shaped material constant rate feeding unit of the manufacturing apparatus.

FIG. 13 is a front view seen from rearwardly of the constant rate feeding unit.

FIG. 14 is a side view showing a cutter unit.

FIG. 15 is a front view showing the cutter unit.

FIG. 16 is a plan view showing the cutter unit.

FIG. 17 is a plan view showing a portion of a holding table of the manufacturing apparatus.

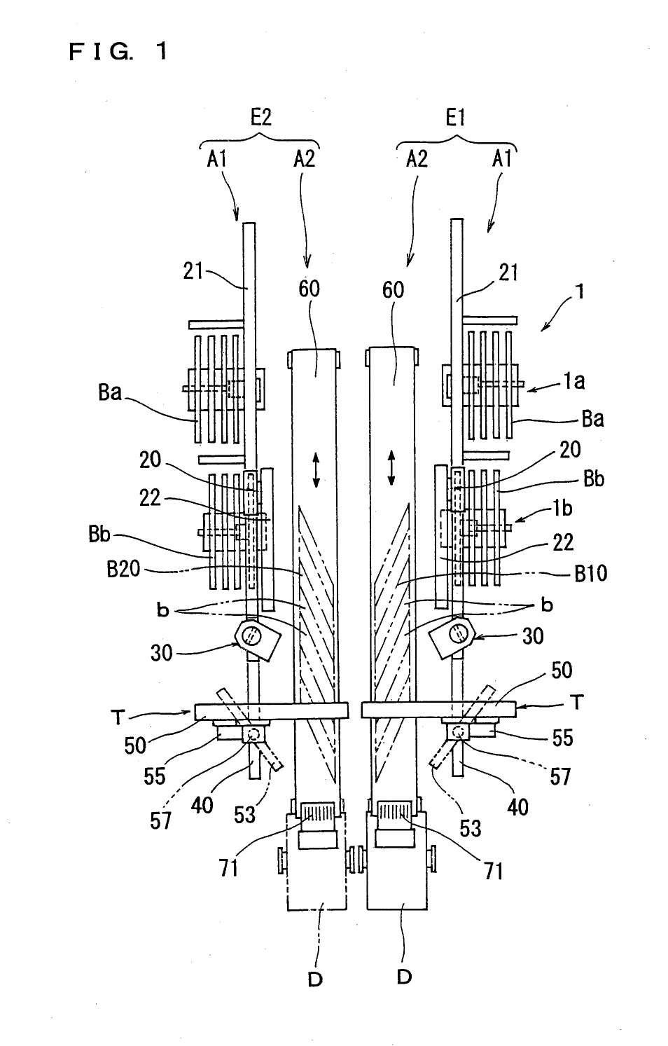

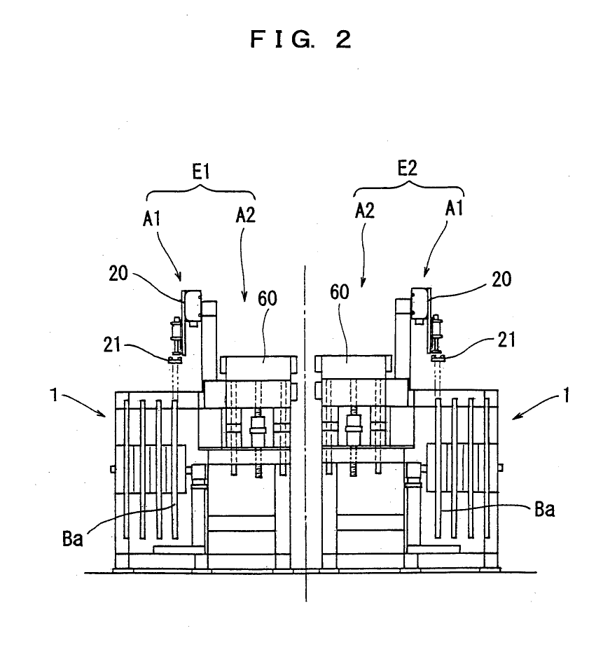

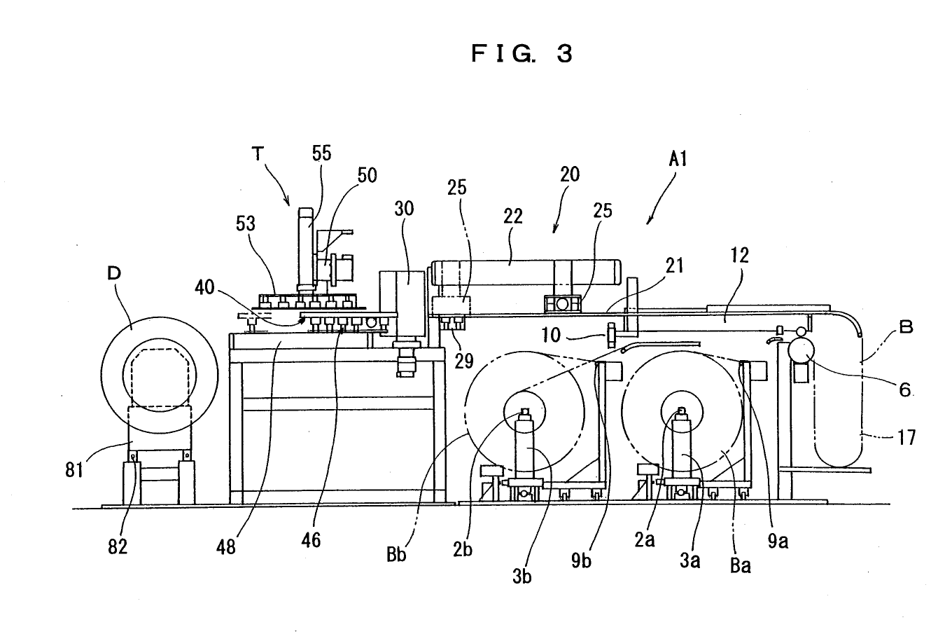

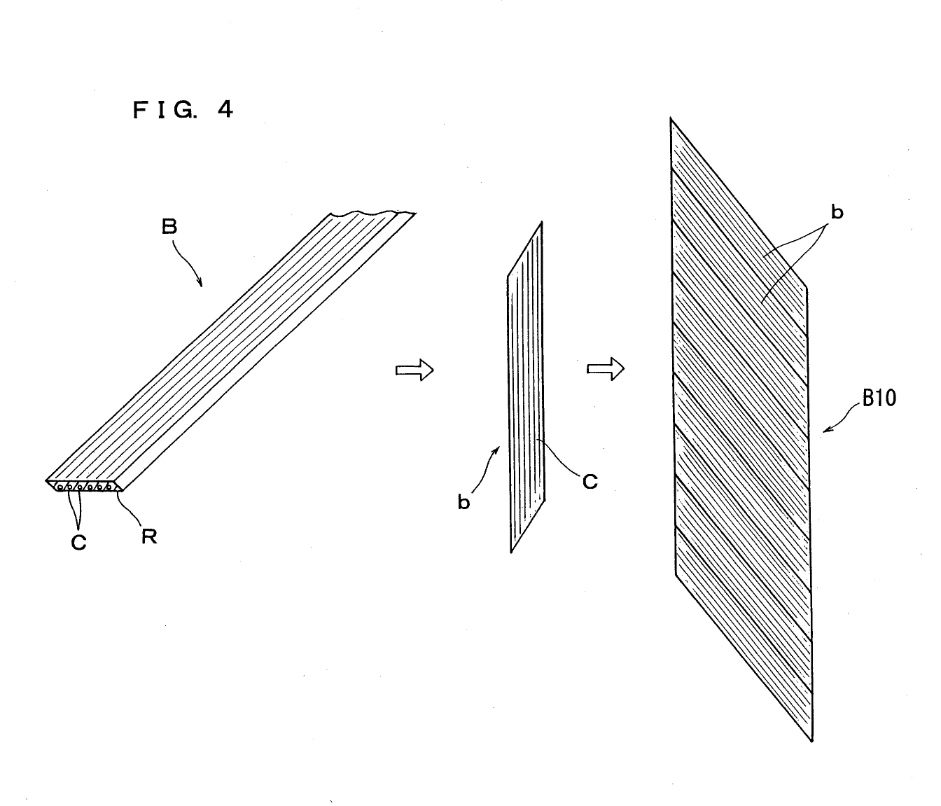

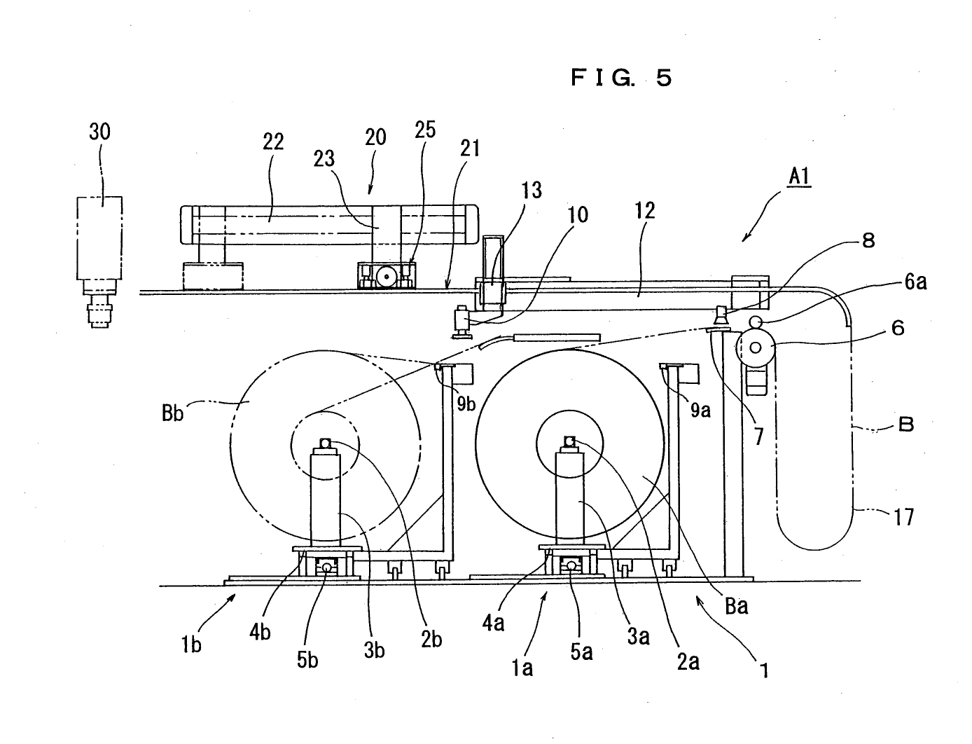

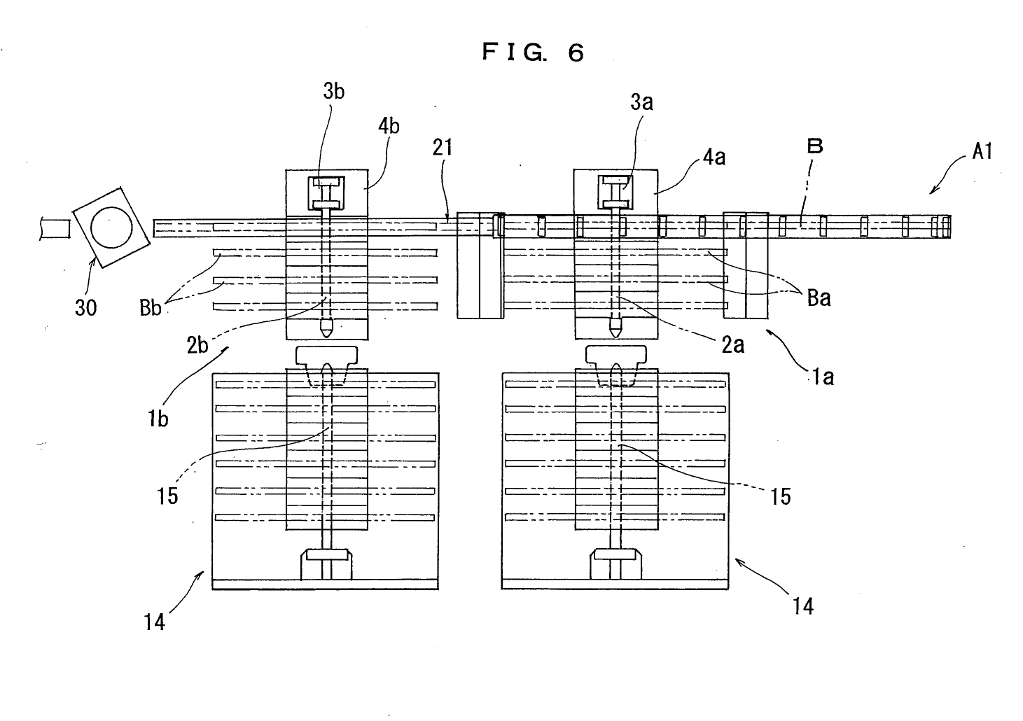

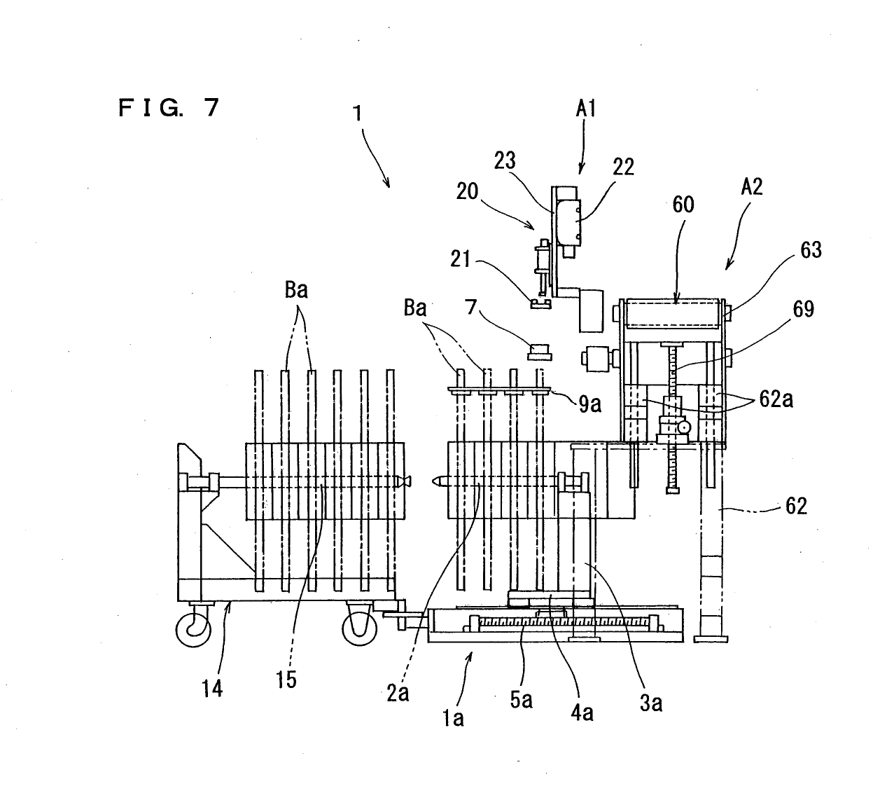

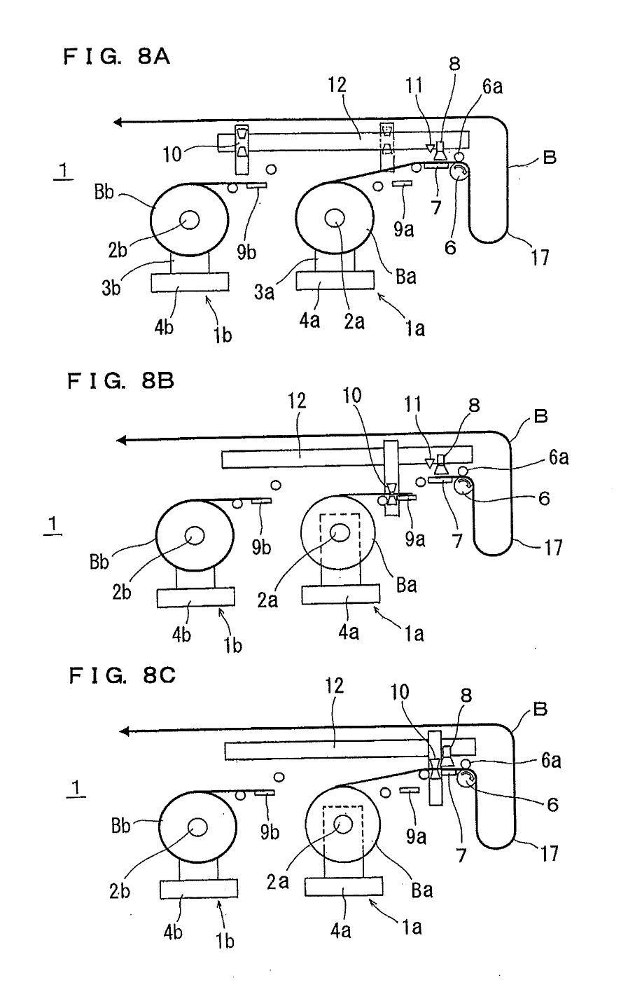

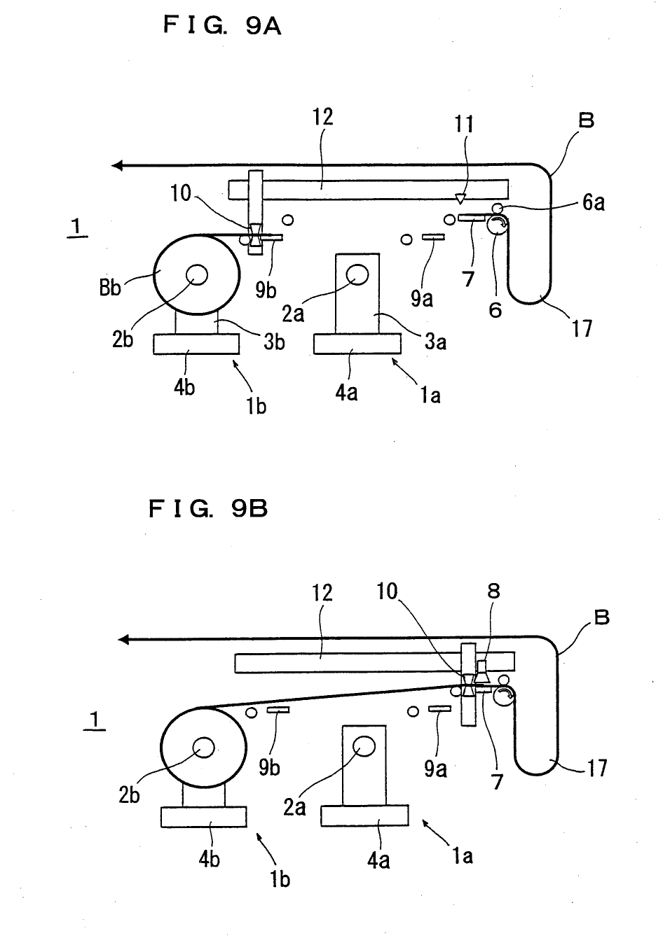

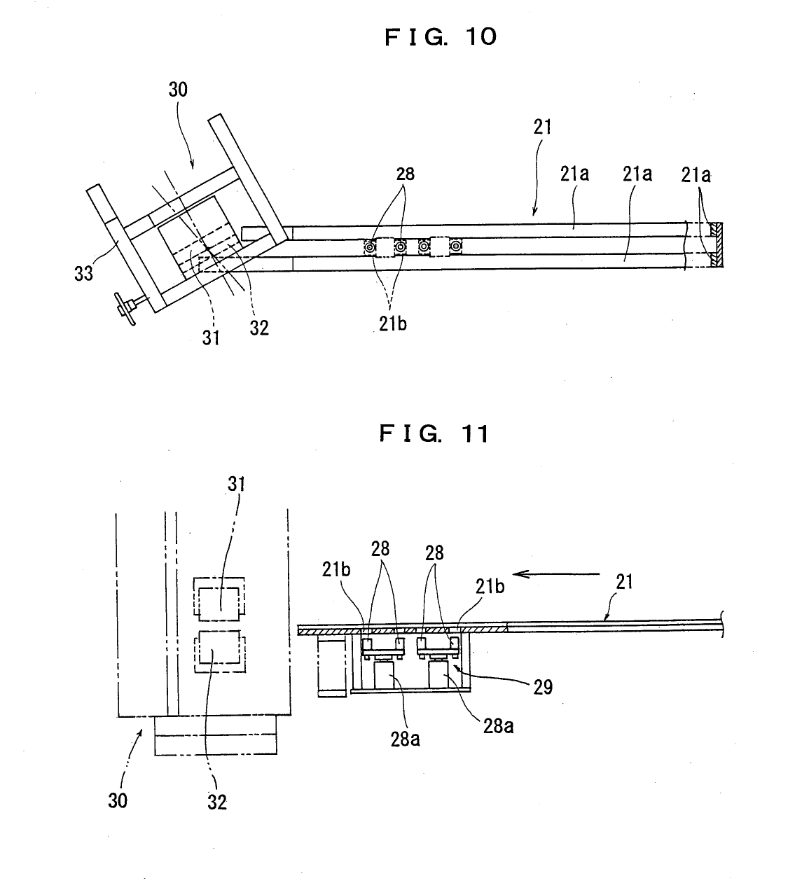

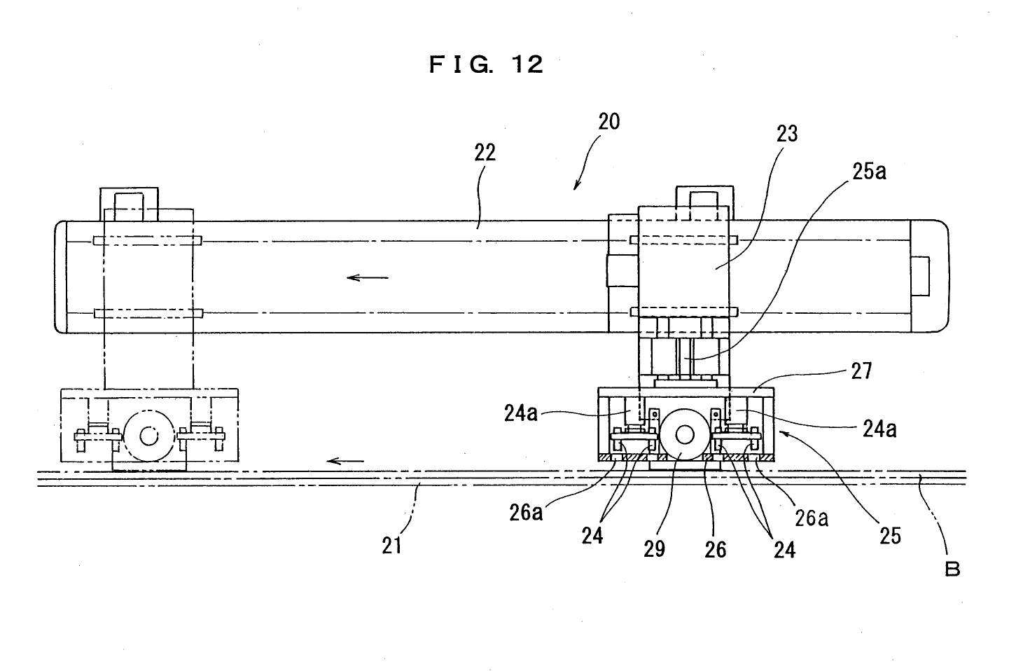

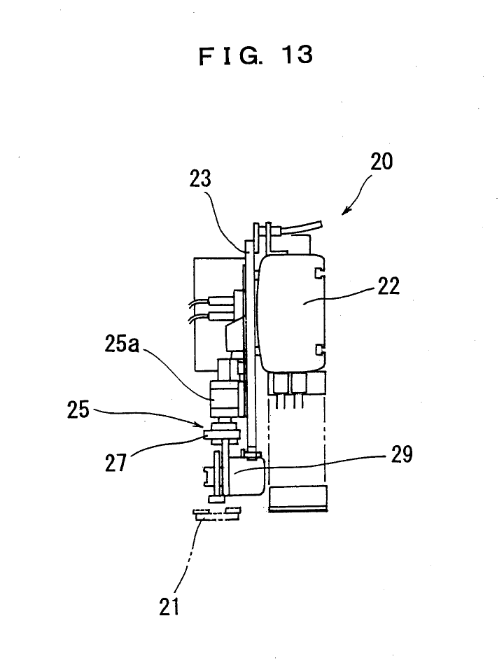

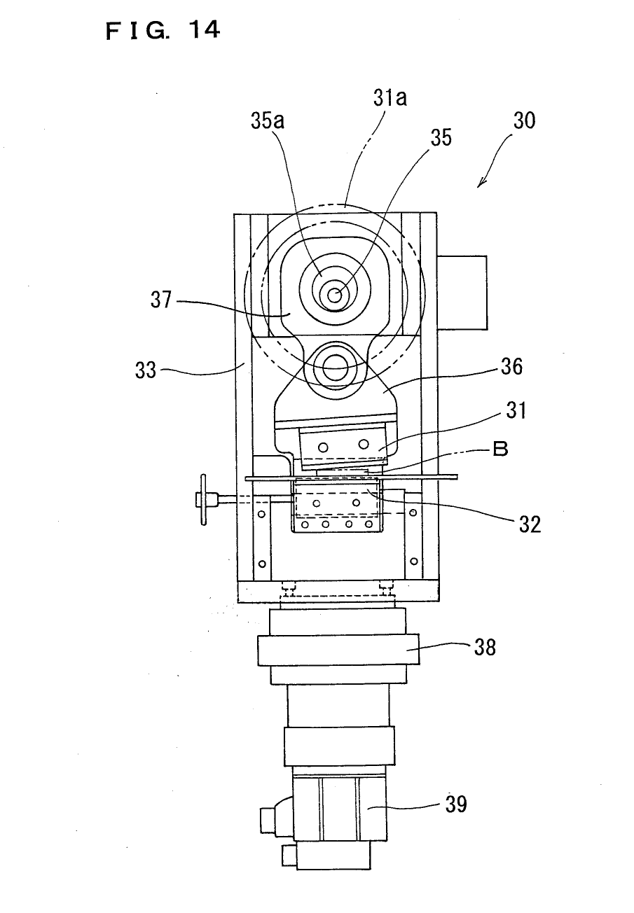

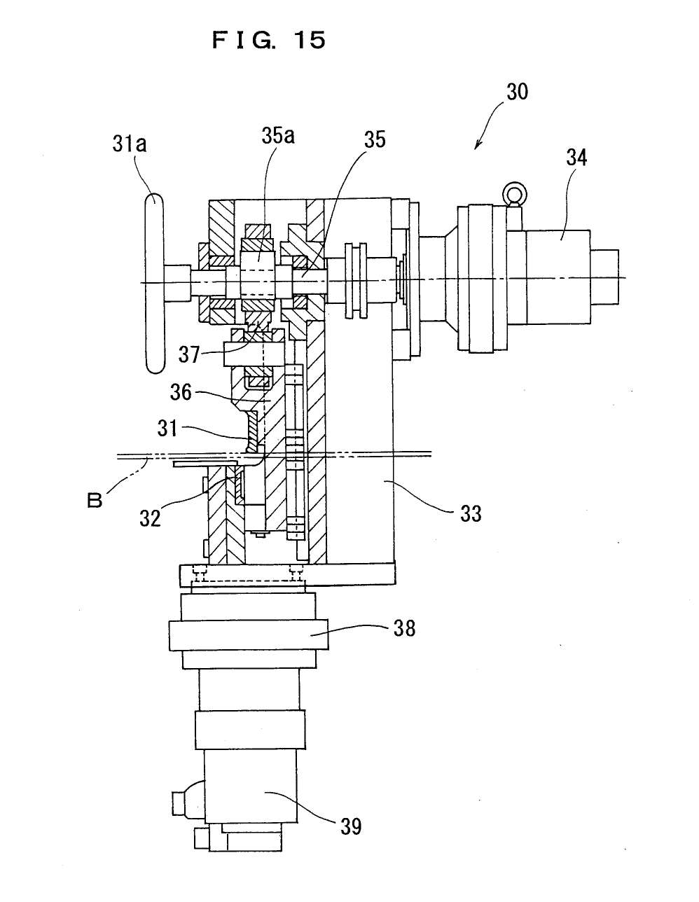

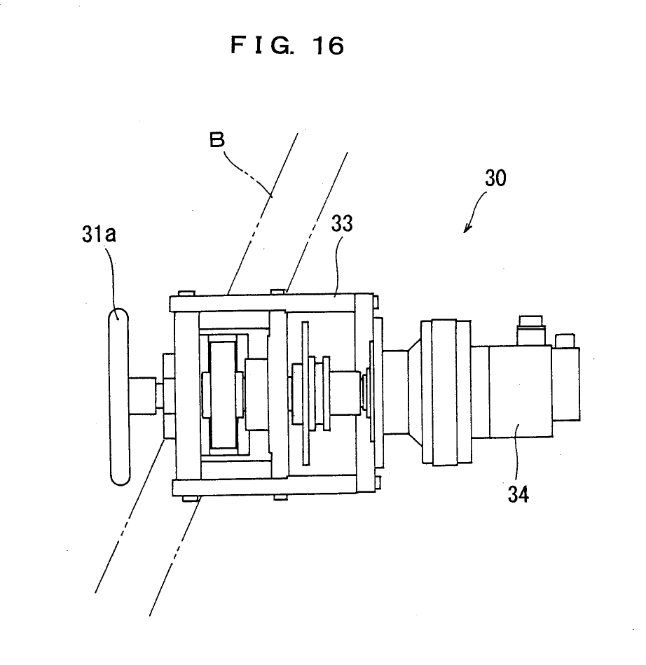

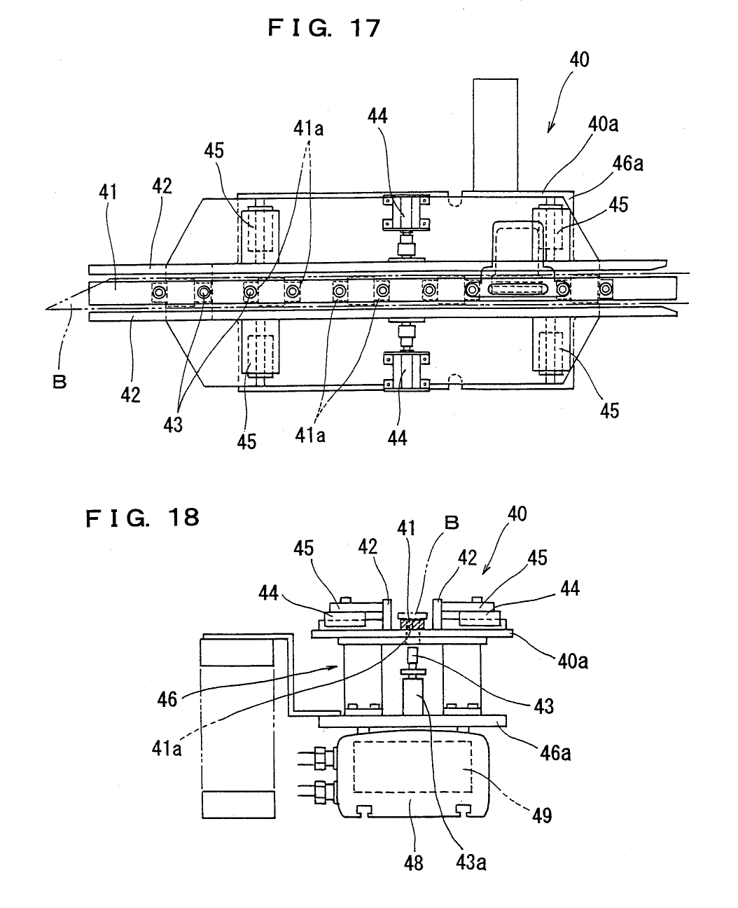

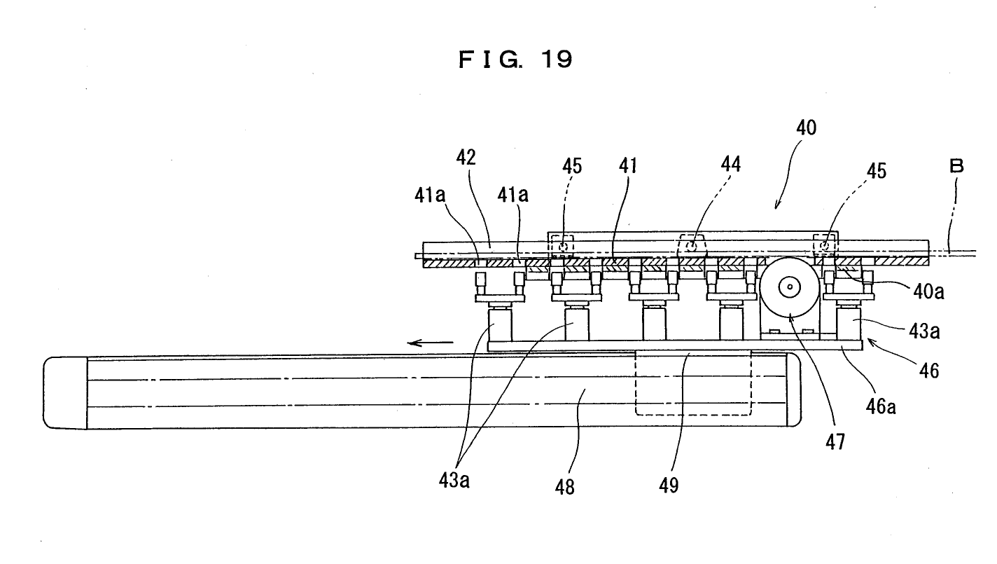

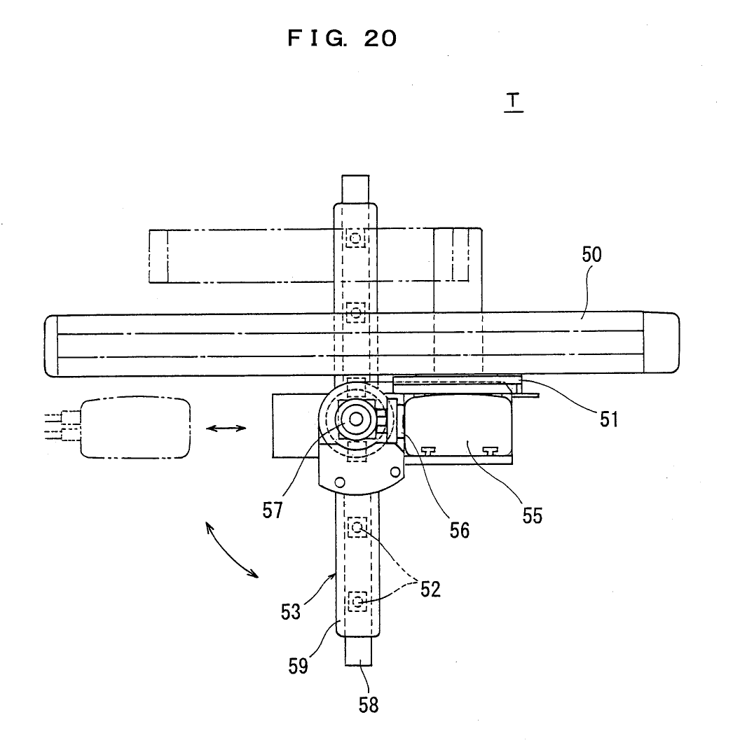

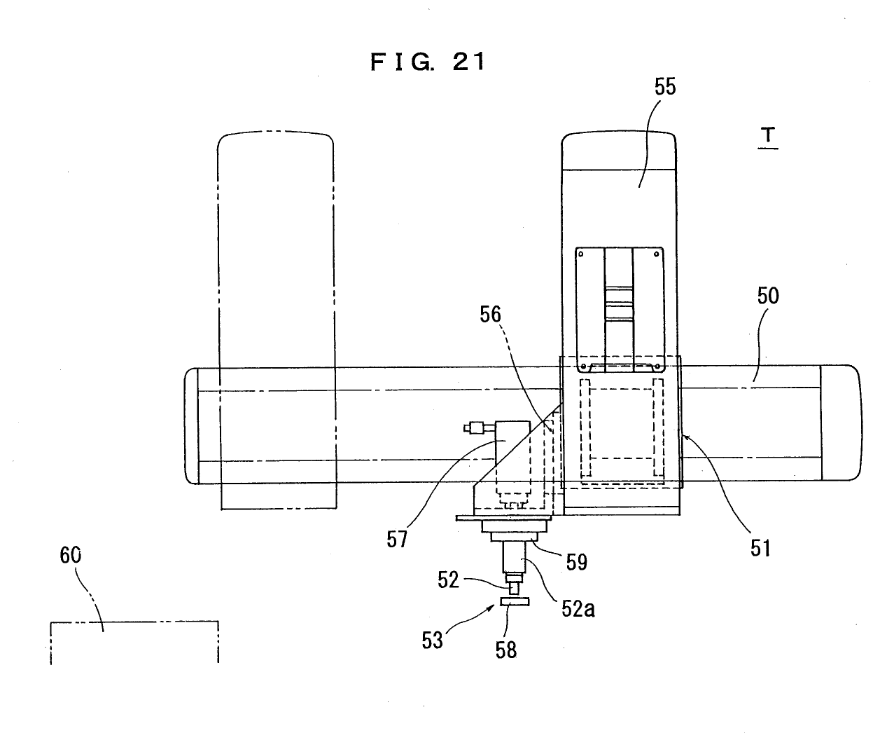

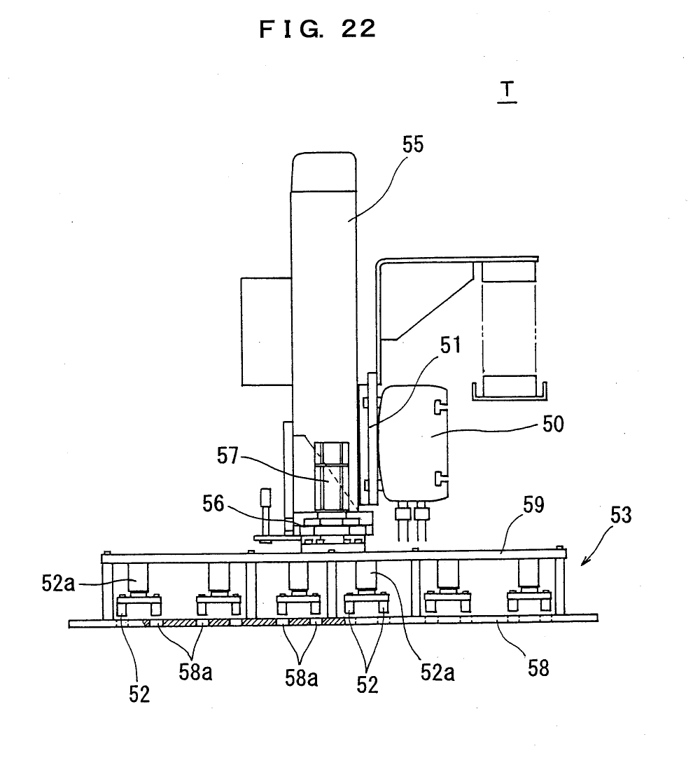

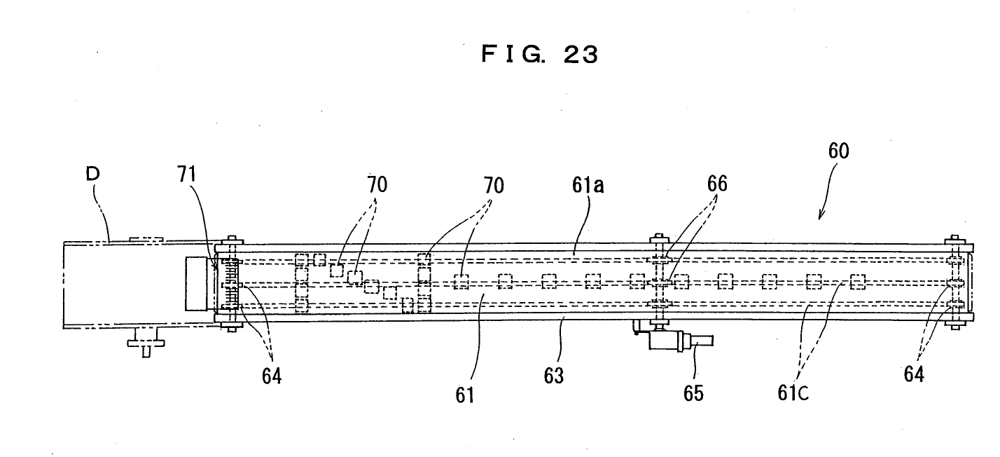

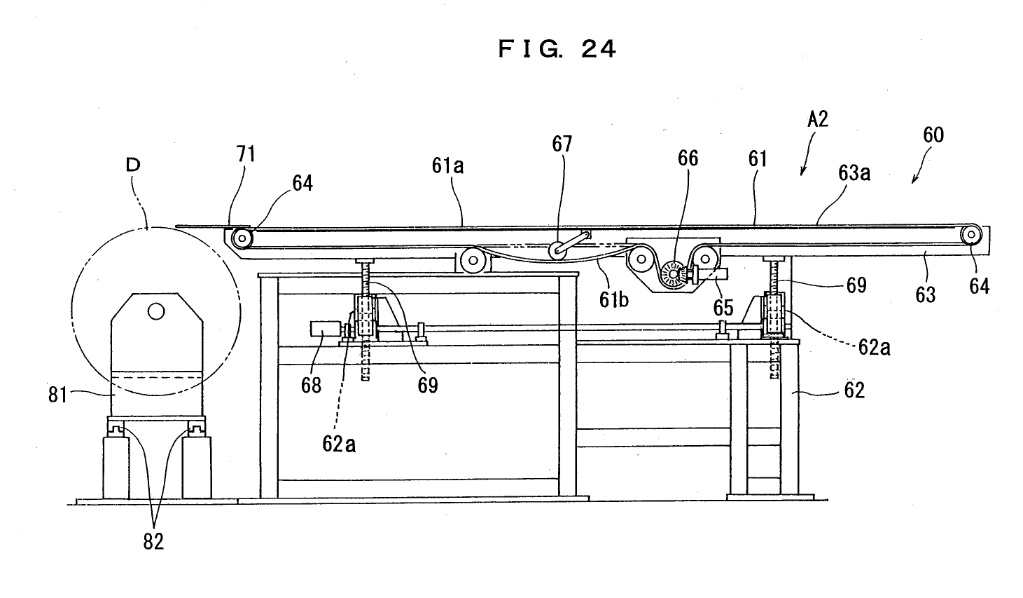

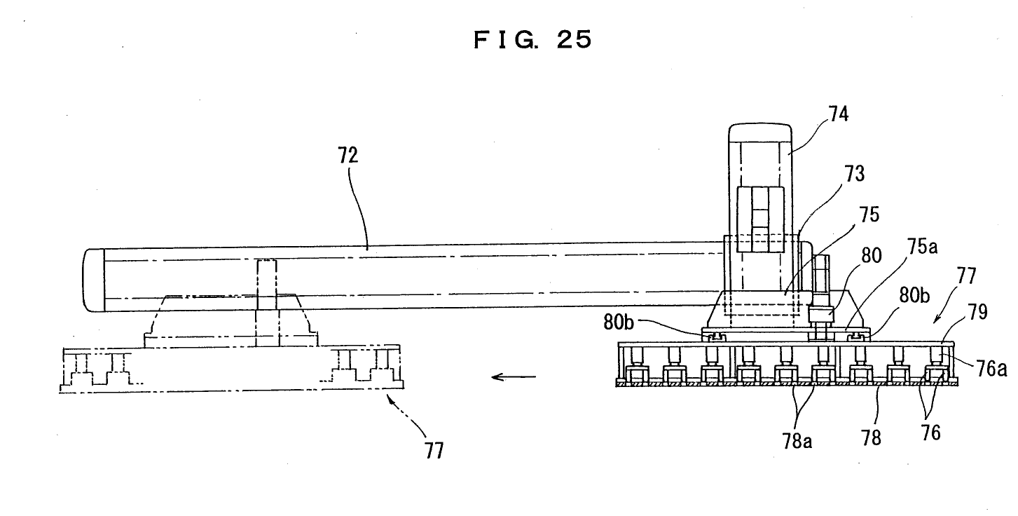

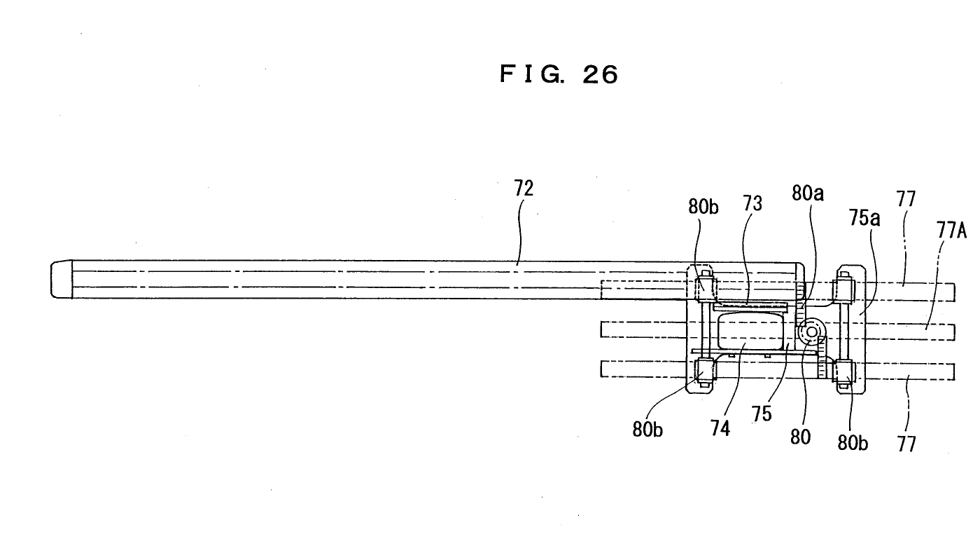

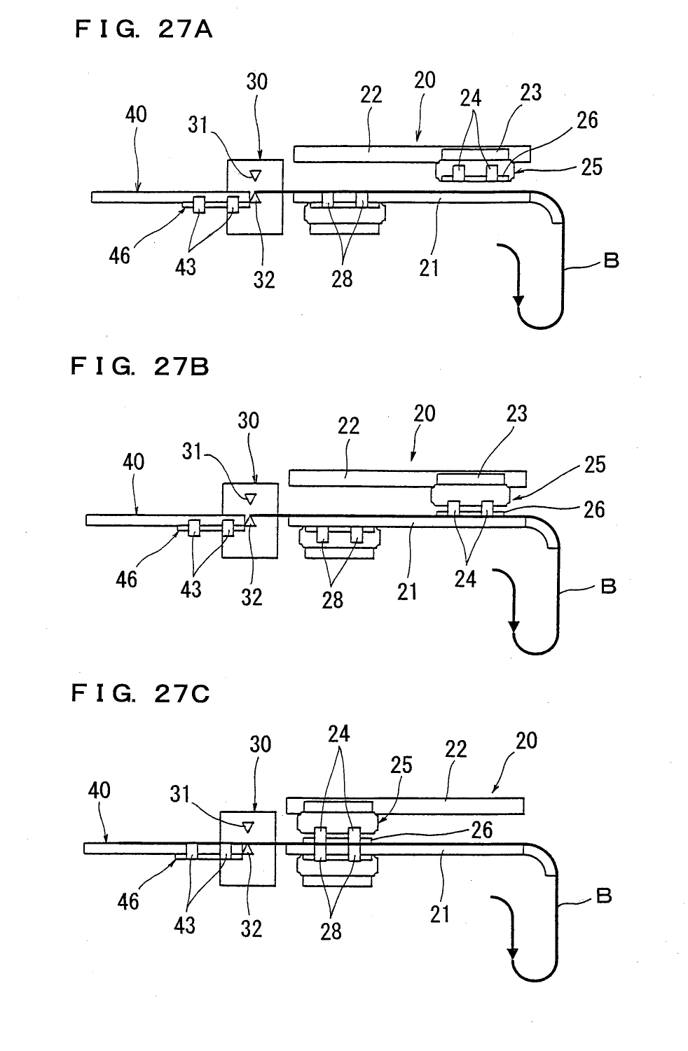

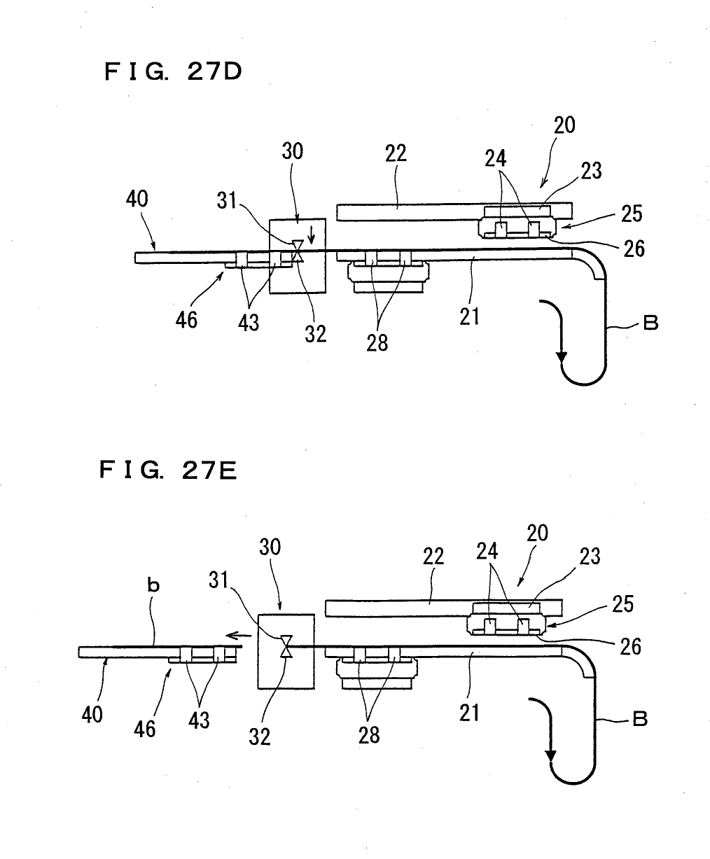

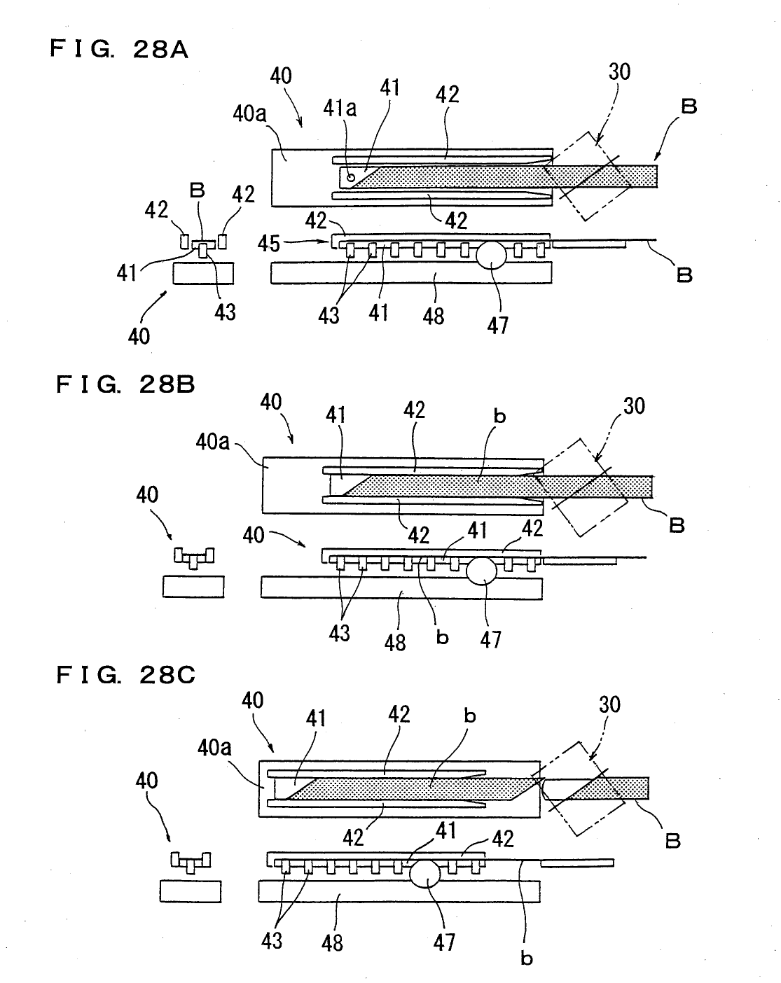

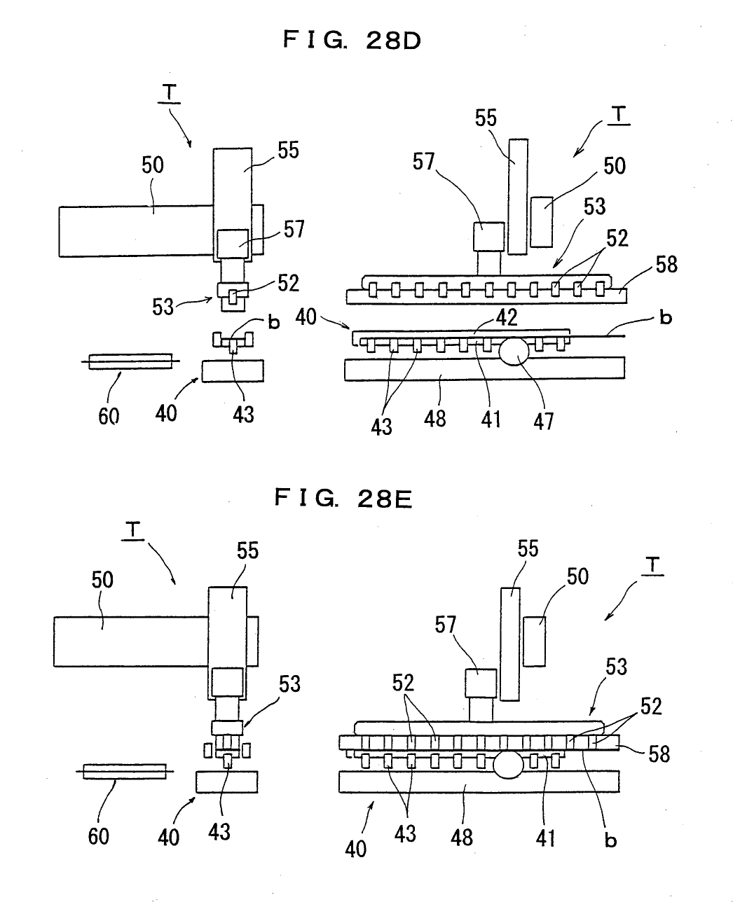

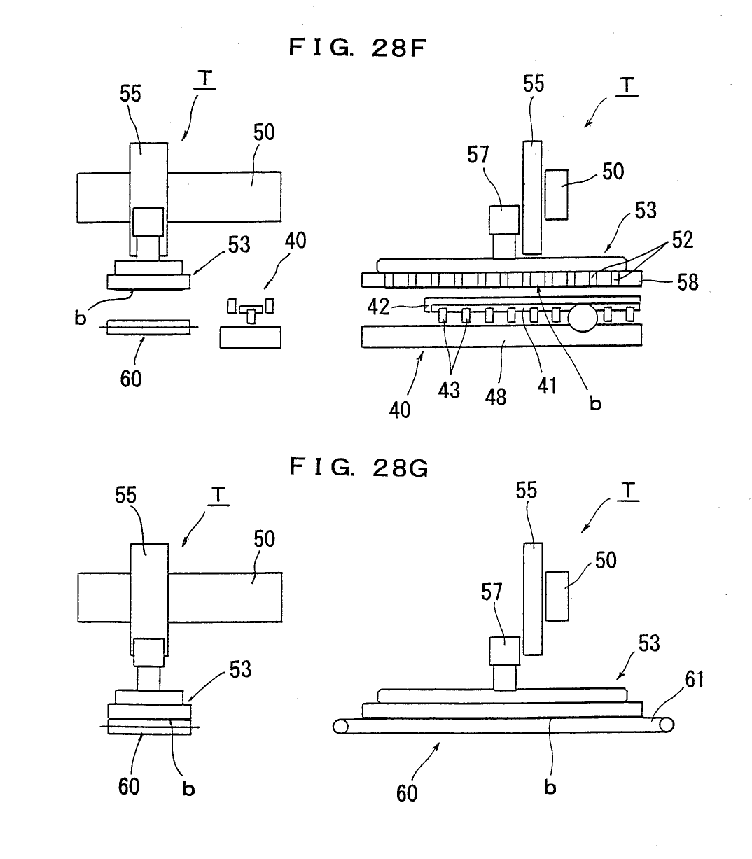

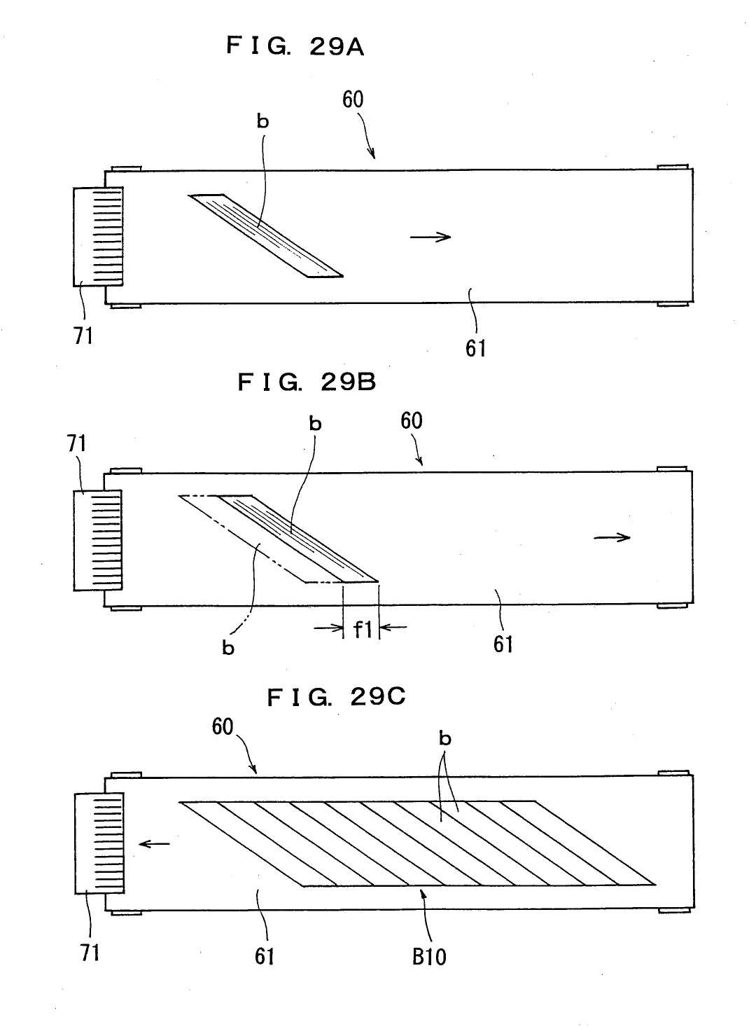

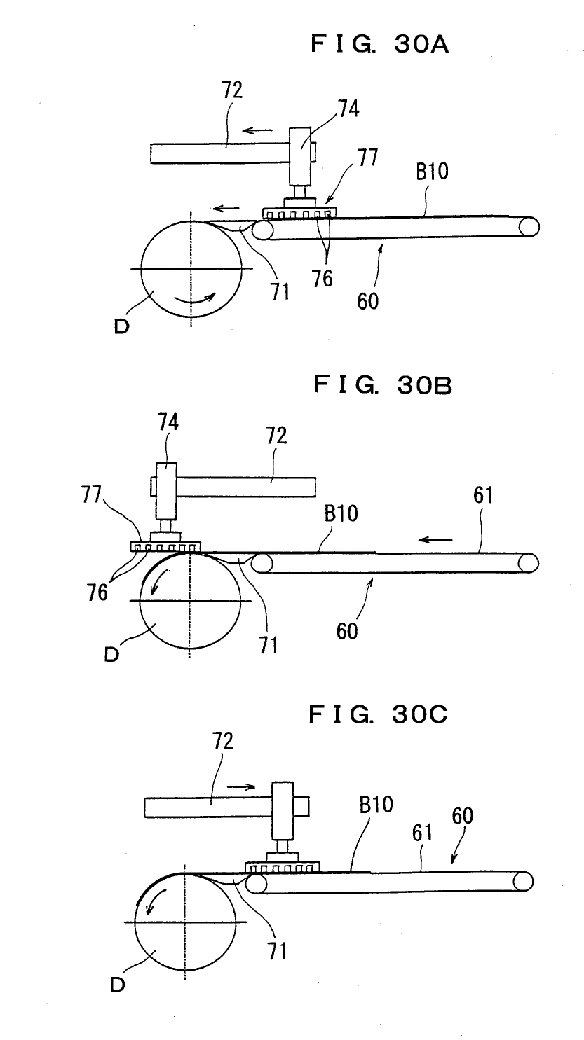

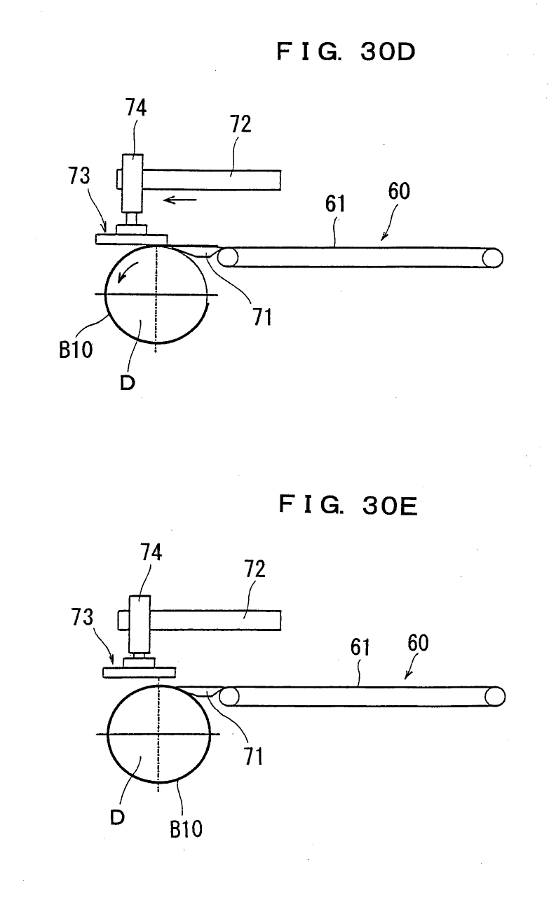

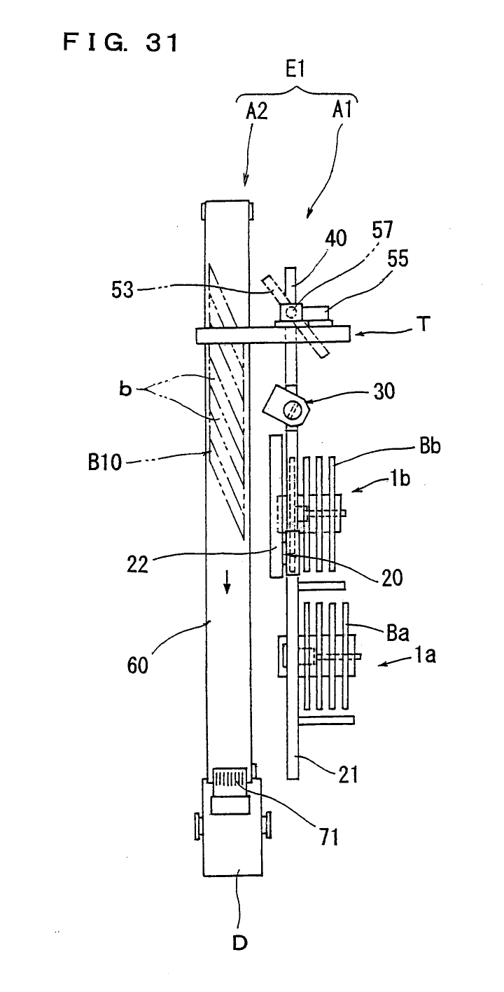

FIG. 15 is a front view showing the portion of the holding table.

FIG. 19 is a side view showing the portion of the holding table.

FIG. 20 is a plan view showing a transfer unit in the manufacturing apparatus.

FIG. 21 is a front view showing the transfer unit.

FIG. 22 is a side view showing the transfer unit.

FIG. 23 is a schematic, plan view showing the whole of an alignment conveyor of an alignment processing section in the manufacturing apparatus.

FIG. 24 is a side view showing a portion of the alignment conveyor.

FIG. 25 is a side view showing an outline of a sticking unit for a forming drum.

FIG. 26 is a plan view showing the sticking unit.

FIG. 27A is a schematic view illustrating an operating step of constant rate feeding of a band-shaped material.

FIG. 27B is a schematic view illustrating an operating step of constant rate feeding of a band-shaped material.

FIG. 27C is a schematic view illustrating an operating step of constant rate feeding of a band-shaped material.

FIG. 27D is a schematic view illustrating an operating step of constant rate feeding of a band-shaped material.

FIG. 27E is a schematic view illustrating an operating step of constant rate feeding of a band-shaped material.

FIG. 28A is a schematic view illustrating respective operating steps of holding of a band-shaped material, separation of the band-shaped material after cut, transfer of a belt material piece, etc.

FIG. 28B is a schematic view illustrating respective operating steps of holding of a band-shaped material, separation of the band-shaped material after cut, transfer of a belt material piece, etc.

FIG. 28C is a schematic view illustrating respective operating steps of holding of a band-shaped material, separation of the band-shaped material after cut, transfer of a belt material piece, etc.

FIG. 28D is a schematic view illustrating respective operating steps of holding of a band-shaped material, separation of the band-shaped material after cut, transfer of a belt material piece, etc.

FIG. 28E is a schematic view illustrating respective operating steps of holding of a band-shaped material, separation of the band-shaped material after cut, transfer of a belt material piece, etc.

FIG. 28F is a schematic view illustrating respective operating steps of holding of a band-shaped material, separation of the band-shaped material after cut, transfer of a belt material piece, etc.

FIG. 28G is a schematic view illustrating respective operating steps of holding of a band-shaped material, separation of the band-shaped material after cut, transfer of a belt material piece, etc.

FIG. 29A is a schematic view illustrating an operating step in a state, in which the belt material pieces are aligned on an alignment conveyor.

FIG. 29B is a schematic view illustrating an operating step in a state, in which the belt material pieces are aligned on the alignment conveyor.

FIG. 29C is a schematic view illustrating an operating step in a state, in which the belt material pieces are aligned on the alignment conveyor.

FIG. 30A is a schematic view illustrating an operating step in a state, in which a belt member is stuck.

FIG. 30B is a schematic view illustrating an operating step in a state, in which the belt member is stuck.

FIG. 30C is a schematic view illustrating an operating step in a state, in which the belt member is stuck.

FIG. 30D is a schematic view illustrating an operating step in a state, in which the belt member is stuck.

FIG. 30E is a schematic view illustrating an operating step in a state, in which the belt member is stuck.

FIG. 31 is a schematic, plan view partially showing other embodiments.

### DESCRIPTION OF REFERENCE NUMERALS AND SIGNS

A1: cut processing section, A2: alignment processing section, B: belt band-shaped material, B10, B20: belt member, b: belt material piece, Ba, Bb: wound body, C: reinforcement cord, D: forming drum, E1, E2: manufacturing apparatus, T: transfer unit, 1: material feeding section, 1a, 1b: feed and support section, 2a, 2b: support shaft, 3a, 3b: column, 4a, 4b: table, 5a, 5b: ball screw mechanism, 6: feed drive roller, 6a: holding roller, 7: receiving board, 8: holding unit, 9a, 9b: standby board, 10: hand unit, 11: sensor, 12: moving means, 13: moving body, 14: carriage, 15: support shaft, 17: dancer section, 20: constant rate feeding unit, 21: feed table, 21a, 21b: guide, 22: moving means, 23: moving body, 24: magnetic attraction means, 25: holding member, 28: magnetic attraction means, 30: cutter unit, 31, 32: cutter blade, 33: frame member, 34: servomotor, 35: cam shaft, 35a: cam, 36: arm member, 37: connecting member, 40: holding table, 41: table body, 42, 42: guide bar, 43: magnetic attraction means, 46: holding member, 48: moving means, 49: moving body, 50: moving means, 51: moving body, 52: magnetic attraction means, 55: moving means for lifting, 56: lifting member, 57: turning means, 60: alignment conveyor, 61: conveyor body, 62: frame, 64: pulley, 65: drive motor, 66: drive pulley, 67: tension roller, 68: motor, 69: lifting means, 70: magnetic attraction means, 71: scraper, 72: moving means, 73: moving body, 74: moving means for lifting, 75: lifting member, 76: magnetic attraction means, 77: holding member, 78: holding plate, 78a: through-hole, 79: support plate, 80: servomotor, 80a: pinion/rack mechanism, 80b: guide

1.-2. (canceled)

3. An apparatus for manufacturing a tire belt used for manufacture of a tire, comprising a cut processing section for cutting a lengthy belt band-shaped material with metallic reinforcement cords embedded in parallel in a rubber material to a predetermined linear dimension while feeding the belt band-shaped material intermittently in a longitudinal direction, an alignment processing section, which includes an alignment conveyor arranged in parallel to the cut processing section and sequentially aligns and joins belt material pieces as cut on the alignment conveyor, and a transfer unit, which transfers the belt material piece cut in the cut processing section onto the alignment conveyor, and
wherein the cut processing section comprises a material feeding section for holding the lengthy belt band-shaped material in a drawable manner, a constant rate feeding unit for intermittently feeding the band-shaped material, which is drawn from the material feeding section, by a set, predetermined length along a predetermined feeding section, a cutter unit for cutting a leading end portion of the band-shaped material to a predetermined length obliquely to a longitudinal direction whenever the band-shaped material is intermittently fed by the constant rate feeding unit, and a holding table for receiving the leading end portion of the band-shaped material having passed a portion of the cutter unit forwardly of the cutter unit in a feed direction to hold the same in a predetermined position,
the transfer unit comprises a moving body bridging the cut processing section and the alignment processing section thereabove in an intersecting direction to be able to reciprocate, and is provided so that holding means for attracting and holding the belt material piece is supported on the moving body to go up and down and to turn, after the cut by the cutter unit, the belt material piece as cut on the holding table is attracted and held by the holding means to be lifted to be transferred onto the alignment conveyor of the alignment processing section and to turn with an oblique cut end thereof oriented in the same direction as a conveyance direction of the alignment conveyor to be placed on the alignment conveyor with a cut end thereof trued up, and
the alignment processing section is provided so that whenever the belt material piece is transferred onto the alignment conveyor, the alignment conveyor is intermittently forwarded by a dimension corresponding to the belt material piece to sequentially align respective belt material pieces obliquely to join sides thereof.

4. The apparatus for manufacturing a tire belt according to claim 3, further comprising, as a feeding section of the belt band-shaped material drawn from the material feeding section, a feed table for maintaining the band-shaped material horizontal to feed the same in a longitudinal direction, and wherein holding means is provided below a position in the vicinity of an end of the feed table toward the cutter unit to hold the belt band-shaped material on the feed table at the time of cut by the cutter unit.

5. The apparatus for manufacturing a tire belt according to claim 3 or 4, wherein the cutter unit includes cutter blades paired vertically to interpose therebetween a fed portion of the belt band-shaped material and is provided so that the both cutter blades can cut the band-shaped material obliquely to a length thereof and an oblique angular direction of the both cutter blades relative to a length of the band-shaped material can be changed.

6. The apparatus for manufacturing a tire belt according to claim 5, wherein an upper one of the vertical pair of cutter blades of the cutter unit is mounted to an arm member, which is connected to a cam shaft rotated by a servomotor to move vertically.

7. The apparatus for manufacturing a tire belt according to claim 3 or 4, wherein the holding table includes a table body, which receives a leading end portion of the belt band-shaped material, and a pair of positioning guides are provided on both sides of the table body to enable displacement in a manner to interpose the band-shaped material as fed between both sides.

8. The apparatus for manufacturing a tire belt according to claim 7, wherein the holding table is supported to be able to advance and retreat in a feed direction of the belt band-shaped material and provided so that after the band-shaped material is cut, it advances forward in the feed direction in a state of holding a belt material piece as cut and is separated from the cutter unit.

9. The apparatus for manufacturing a tire belt according to claim 3 or 4, wherein the alignment conveyor is provided with magnetic attraction means, which is approximate to a back surface of a conveyor body in the vicinity of a position, to which the belt material piece is transferred by the transfer unit, to hold the belt material piece on the conveyor body.

10. The apparatus for manufacturing a tire belt according to claim 3 or 4, wherein the alignment conveyor is mounted so that a forward side end thereof is opposed to a forming drum positioned to have a belt member stuck thereto in manufacture of a tire, comprises a stick hand unit including a moving body capable of reciprocating between above the conveyor and above the forming drum and a holding body, which is supported on the moving body to be able to go up and down and turn and on which attraction means is arranged, and is provided so that a leading end portion of the belt member on the alignment conveyor is attracted and held by the attraction means to be transferred onto the forming drum in synchronism with forwarding of the alignment conveyor to be stuck thereto.

11. The apparatus for manufacturing a tire belt according to claim 3 or 4, wherein the material feeding section is provided below a forwarding section, which feeds the belt band-shaped material in a longitudinal direction, to enable drawing the band-shaped material in an opposite direction to the feed direction, and constructed to change orientation of the band-shaped material as drawn to feed the band-shaped material upward to the forwarding section from a rear end side in the feed direction.

12. The apparatus for manufacturing a tire belt according to claim 11, wherein the material feeding section comprises a table of a column including a support shaft to support a plurality of wound bodies, round which the belt band-shaped material is wound in a rolled manner, in parallel at intervals and provided to permit the band-shaped material on the wound body positioned in a predetermined drawn position to be drawn and to bear the support shaft, and provided to be able to move in the axial direction of the support shaft, and constructed to sequentially move the respective wound bodies to the predetermined drawn position to permit the respective band-shaped materials to be drawn.

13. The apparatus for manufacturing a tire belt according to claim 11, wherein the material feeding section is provided with an automatic connection device, which connects a leading end of a band-shaped material on the wound body to a trailing end of a band-shaped material previously drawn whenever the wound body is positioned in a predetermined drawn position.
